(19) United States
(12) Patent Application Publication
(10) Pub. No.: US 2026/0205828 A1
(43) Pub. Date: Jul. 16, 2026

(54) UNCREWED AERIAL VEHICLE FLIGHT PATH OPTIMIZATION

(71) Applicant: QUALCOMM Incorporated, San Diego, CA (US)

(72) Inventors: Sitaramanjaneyulu KANAMARLAPUDI, San Diego, CA (US); Umesh PHUYAL, San Diego, CA (US)

(21) Appl. No.: 19/559,337

(22) Filed: Mar. 6, 2026

Related U.S. Application Data
(63) Continuation of application No. 18/507,922, filed on Nov. 13, 2023.

(51) Int. Cl. H04W 16/26; B64U 10/14; G08G 5/34; H04W 36/32; H04W 36/36; H04W 84/06

(52) U.S. Cl. CPC H04W 16/26; G08G 5/34; H04W 36/324; H04W 36/362; B64U 10/14; B64U 2201/20; H04W 84/06

(57) ABSTRACT

Various aspects of the present disclosure generally relate to wireless communication. In some aspects, an apparatus may receive input information regarding a radio access network (RAN) that provides coverage for an unmanned aerial vehicle (UAV) user equipment (UE), wherein the input information includes at least one of minimization of drive test (MDT) reporting, self-organizing network (SON) reporting, or information regarding a radio condition of the RAN. The apparatus may obtain output information using an artificial intelligence or machine learning (AI/ML) model and the input information, wherein the output information indicates a reconfiguration of at least one of: a network node of the RAN, or the UAV UE. The apparatus may configure at least one of the network node or the UAV UE in accordance with the output information. Numerous other aspects are described.

### CROSS-REFERENCE TO RELATED APPLICATION

This application is a continuation of and claims priority to U.S. patent application Ser. No. 18/507,922, filed Nov. 13, 2023, which is incorporated herein by reference in its entirety.

### FIELD OF THE DISCLOSURE

Aspects of the present disclosure generally relate to wireless communication and specifically relate to techniques, apparatuses, and methods for uncrewed aerial vehicle (UAV) flight path optimization.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some aspects, a method of wireless communication performed by a user equipment (UE) includes transmitting flight path information regarding a flight path of the UE; receiving a modification to the flight path information, wherein the modification is associated with a radio condition, wherein the radio condition is associated with the flight path; and triggering movement of the UE in association with the modification to the flight path information.

In some aspects, a method of wireless communication performed by a user equipment (UE) includes receiving a first configuration for a mobility operation; transmitting flight path information regarding a flight path of the UE; receiving, in association with the flight path information, a second configuration for the mobility operation; and performing the mobility operation in accordance with the second configuration.

In some aspects, a method of wireless communication performed by a network node includes transmitting a configuration associated with a mobility operation of a user equipment (UE), wherein the UE is associated with an uncrewed aerial vehicle (UAV), and wherein the configuration is derived from a target cell type of the mobility operation; and communicating for the mobility operation in accordance with the configuration.

In some aspects, a method performed by an apparatus includes receiving input information regarding a radio access network (RAN) that provides coverage for an unmanned aerial vehicle (UAV) user equipment (UE), wherein the input information includes at least one of minimization of drive test (MDT) reporting, self-organizing network (SON) reporting, or information regarding a radio condition of the RAN; obtaining output information using an artificial intelligence or machine learning (AI/ML) model and the input information, wherein the output information indicates a reconfiguration of at least one of: a network node of the RAN, or the UAV UE; and configuring at least one of the network node or the UAV UE in accordance with the output information.

In some aspects, a method of wireless communication performed by a network node includes receiving flight path information regarding a flight path of a user equipment (UE); and transmitting, in association with a radio condition associated with the flight path, a modification to the flight path information.

In some aspects, a method of wireless communication performed by a user equipment (UE) includes receiving a first configuration for a mobility operation; transmitting flight path information regarding a flight path of the UE; receiving, in association with the flight path information, a second configuration for the mobility operation; and performing the mobility operation in accordance with the second configuration.

In some aspects, an apparatus configured for wireless communication includes one or more memories comprising processor-executable instructions; and one or more processors configured to execute the processor-executable instructions and cause the apparatus to: transmit flight path information regarding a flight path of the apparatus; receive a modification to the flight path information, wherein the modification is associated with a radio condition, wherein the radio condition is associated with the flight path; and trigger movement of the apparatus in association with the modification to the flight path information.

In some aspects, an apparatus configured for wireless communication includes one or more memories comprising processor-executable instructions; and one or more processors configured to execute the processor-executable instructions and cause the apparatus to: receive a first configuration for a mobility operation; transmit flight path information regarding a flight path of the apparatus; receive, in association with the flight path information, a second configuration for the mobility operation; and perform the mobility operation in accordance with the second configuration.

In some aspects, an apparatus configured for wireless communication includes one or more memories comprising processor-executable instructions; and one or more processors configured to execute the processor-executable instructions and cause the apparatus to: transmit a configuration associated with a mobility operation of a user equipment (UE), wherein the UE is associated with an uncrewed aerial vehicle (UAV), and wherein the configuration is derived from a target cell type of the mobility operation; and communicate for the mobility operation in accordance with the configuration.

In some aspects, an apparatus configured for wireless communication includes one or more memories comprising processor-executable instructions; and one or more processors configured to execute the processor-executable instructions and cause the apparatus to: receive input information regarding a radio access network (RAN) that provides coverage for an unmanned aerial vehicle (UAV) user equipment (UE), wherein the input information includes at least one of minimization of drive test (MDT) reporting, self-organizing network (SON) reporting, or information regarding a radio condition of the RAN; obtain output information using an artificial intelligence or machine learning (AI/ML) model and the input information, wherein the output information indicates a reconfiguration of at least one of: a network node of the RAN, or the UAV UE; and configure at least one of the network node or the UAV UE in accordance with the output information.

In some aspects, an apparatus configured for wireless communication includes one or more memories comprising processor-executable instructions; and one or more processors configured to execute the processor-executable instructions and cause the apparatus to: receive flight path information regarding a flight path of a user equipment (UE); and transmit, in association with a radio condition associated with the flight path, a modification to the flight path information.

In some aspects, an apparatus configured for wireless communication includes one or more memories comprising processor-executable instructions; and one or more processors configured to execute the processor-executable instructions and cause the apparatus to: receive a first configuration for a mobility operation; transmit flight path information regarding a flight path of an apparatus; receive, in association with the flight path information, a second configuration for the mobility operation; and perform the mobility operation in accordance with the second configuration.

In some aspects, a non-transitory computer-readable medium storing a set of instructions for wireless communication includes one or more instructions that, when executed by one or more processors of a user equipment (UE), cause the UE to: transmit flight path information regarding a flight path of the UE; receive a modification to the flight path information, wherein the modification is associated with a radio condition, wherein the radio condition is associated with the flight path; and trigger movement of the UE in association with the modification to the flight path information.

In some aspects, a non-transitory computer-readable medium storing a set of instructions for wireless communication includes one or more instructions that, when executed by one or more processors of a user equipment (UE), cause the UE to: receive a first configuration for a mobility operation; transmit flight path information regarding a flight path of the UE; receive, in association with the flight path information, a second configuration for the mobility operation; and perform the mobility operation in accordance with the second configuration.

In some aspects, a non-transitory computer-readable medium storing a set of instructions for wireless communication includes one or more instructions that, when executed by one or more processors of a network node, cause the network node to: transmit a configuration associated with a mobility operation of a user equipment (UE), wherein the UE is associated with an uncrewed aerial vehicle (UAV), and wherein the configuration is derived from a target cell type of the mobility operation; and communicate for the mobility operation in accordance with the configuration.

In some aspects, a non-transitory computer-readable medium storing a set of instructions for wireless communication includes one or more instructions that, when executed by one or more processors of an apparatus, cause the apparatus to: receive input information regarding a radio access network (RAN) that provides coverage for an unmanned aerial vehicle (UAV) user equipment (UE), wherein the input information includes at least one of minimization of drive test (MDT) reporting, self-organizing network (SON) reporting, or information regarding a radio condition of the RAN; obtain output information using an artificial intelligence or machine learning (AI/ML) model and the input information, wherein the output information indicates a reconfiguration of at least one of: a network node of the RAN, or the UAV UE; and configure at least one of the network node or the UAV UE in accordance with the output information.

In some aspects, a non-transitory computer-readable medium storing a set of instructions for wireless communication includes one or more instructions that, when executed by one or more processors of a network node, cause the network node to: receive flight path information regarding a flight path of a user equipment (UE); and transmit, in association with a radio condition associated with the flight path, a modification to the flight path information.

In some aspects, a non-transitory computer-readable medium storing a set of instructions for wireless communication includes one or more instructions that, when executed by one or more processors of an UE, cause the UE to: receive a first configuration for a mobility operation; transmit flight path information regarding a flight path of the UE; receive, in association with the flight path information, a second configuration for the mobility operation; and perform the mobility operation in accordance with the second configuration.

In some aspects, an apparatus for wireless communication includes means for transmitting flight path information regarding a flight path of the apparatus; means for receiving a modification to the flight path information, wherein the modification is associated with a radio condition, wherein the radio condition is associated with the flight path; and means for triggering movement of the apparatus in association with the modification to the flight path information.

In some aspects, an apparatus for wireless communication includes means for receiving a first configuration for a mobility operation; means for transmitting flight path information regarding a flight path of the apparatus; means for receiving, in association with the flight path information, a second configuration for the mobility operation; and means for performing the mobility operation in accordance with the second configuration.

In some aspects, an apparatus for wireless communication includes means for transmitting a configuration associated with a mobility operation of a user equipment (UE), wherein the UE is associated with an uncrewed aerial vehicle (UAV), and wherein the configuration is derived from a target cell type of the mobility operation; and means for communicating for the mobility operation in accordance with the configuration.

In some aspects, an apparatus for wireless communication includes means for receiving input information regarding a radio access network (RAN) that provides coverage for an unmanned aerial vehicle (UAV) user equipment (UE), wherein the input information includes at least one of minimization of drive test (MDT) reporting, self-organizing network (SON) reporting, or information regarding a radio condition of the RAN; means for obtaining output information using an artificial intelligence or machine learning (AI/ML) model and the input information, wherein the output information indicates a reconfiguration of at least one of: a network node of the RAN, or the UAV UE; and means for configuring at least one of the network node or the UAV UE in accordance with the output information.

In some aspects, an apparatus for wireless communication includes means for receiving flight path information regarding a flight path of a user equipment (UE); and means for transmitting, in association with a radio condition associated with the flight path, a modification to the flight path information.

In some aspects, an apparatus for wireless communication includes means for receiving a first configuration for a mobility operation; means for transmitting flight path information regarding a flight path of a user equipment (UE); means for receiving, in association with the flight path information, a second configuration for the mobility operation; and means for performing the mobility operation in accordance with the second configuration.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating an example of flight path information associated with a flight path in accordance with the present disclosure.

FIG. 5 is a diagram illustrating an example of uncrewed aerial vehicle (UAV) UEs within a wireless communication network environment in accordance with the present disclosure.

FIG. 6 is a diagram illustrating an example of signaling for modification of a UE's flight path in accordance with the present disclosure.

FIG. 7 is a diagram illustrating an example of signaling for modification of a UE's flight path in accordance with the present disclosure.

FIG. 8 is a diagram illustrating an example of signaling for mobility associated with a target cell type in accordance with the present disclosure.

FIG. 9 is a diagram illustrating an example of signaling for artificial intelligence or machine learning (AI/ML) model based configuration of a radio access network (RAN) or UAV UE in accordance with the present disclosure.

FIG. 10 is a diagram illustrating an example architecture of a functional framework for RAN intelligence enabled by data collection in accordance with the present disclosure.

FIG. 11 is a diagram illustrating an example process performed, for example, at a UE or an apparatus of a UE in accordance with the present disclosure.

FIG. 12 is a diagram illustrating an example process performed, for example, at a UE or an apparatus of a UE in accordance with the present disclosure.

FIG. 13 is a diagram illustrating an example process performed, for example, at a network node or an apparatus of a network node in accordance with the present disclosure.

FIG. 14 is a diagram illustrating an example process performed, for example, at an apparatus or an apparatus of an apparatus in accordance with the present disclosure.

FIG. 15 is a diagram illustrating an example process performed, for example, at a network node or an apparatus of a network node in accordance with the present disclosure.

FIG. 16 is a diagram illustrating an example process performed, for example, at a UE or an apparatus of a UE in accordance with the present disclosure.

FIG. 17 is a diagram illustrating an example of an implementation of code and circuitry for a communications device in accordance with the present disclosure.

FIG. 18 is a diagram illustrating an example of an implementation of code and circuitry for a communications device in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A user equipment (UE) may be implemented in association with an uncrewed aerial vehicle (UAV). For example, the UE may provide radio access for the UAV, thereby enabling remote control and tracking of the UAV, such as in beyond line of sight (BLOS) or beyond visual line of sight (BVLOS) applications. A UE that provides radio access for a UAV may be referred to herein as a UAV UE, or as a UE.

Radio access for UAV UEs may pose certain challenges relative to terrestrial (e.g., ground-level) radio access. For example, UAV UEs may tend to move at a high speed along a flight path. As another example, some networks may primarily be configured to provide ground-level coverage, so coverage gaps may exist in the flight envelope of a UAV UE. As another example, a UAV UE (or the UAV to which a UAV UE is mounted) may have limited battery life or may adhere to a particular itinerary that indicates destinations or timelines of the UAV UE's travel.

A UAV UE may perform measurements according to one or more parameters. These parameters may include, for example, a minimum altitude (H1) and a maximum altitude (H2). When a location of the UAV UE is above H1 and below H2, or above H2 with a hysteresis value, the UAV UE may report one or more measurements to gNB. A vertical range in the air can be divided into different height zones with different H1/H2 triggers for reporting measurements, which enables a network node to identify an exact position (range) of the UAV UE in the air.

The UAV may operate according to a flight path. The flight path may be described or defined by flight path information. Flight path information may include one or more waypoints and time information associated with the one or more waypoints. The waypoints may indicate a path through which the UAV UE moves from a source to a destination, and the time information may indicate times at which the UAV UE is to reach each waypoint. In some aspects, a flight path of a UAV UE may be managed by an original equipment manufacturer (OEM) of the UAV UE or a service provider implementing the UAV UE based on a purpose of the travel and/or locations to be visited by the UE. For example, an inspection UAV may visit different locations and may spend different amounts of time at each location inspecting inventory or the like.

As mentioned, height-based measurements (H1 and H2) may assist in switching a UAV UE from one beam/cell to another beam/cell for continuous coverage. Furthermore, flight path information may assist in planning a next cell to which a UAV UE is to hand over to maintain a threshold coverage. However, a network may dynamically add or remove cells based on multiple factors, such as hours of operation, thermal noise, cell loading, overlapping/multi-layer cell planning. Furthermore, other operational aspects of the network may be controlled by an operations, administration, and maintenance (OAM) entity, a self-organizing network (SON) entity, a radio access network (RAN) intelligent controller (RIC), or the like. Thus, the number of cells and their capabilities are continuously changing based on time of operation as well as other radio planning characteristics, such as operator-specific radio resource management policies.

The variability of the configuration of the RAN may lead to situations where a flight path information, defined by an OEM or Service Provider of the UAV, defines a flight path through sub-optimal radio conditions or that imposes a burden on the RAN. For example, the configuration of the network may change after the flight path information is generated, leading to inadequate coverage or failure to provide threshold performance on the flight path. As another example, a given flight path may cause an undue number of mobility operations (e.g., handovers, beam changes) for a UAV UE. As another example, a given flight path may traverse coverage holes (e.g., zones with lower than a threshold coverage) due to terrain features, regulatory limitations, or the like. Implementing a flight path without concern for coverage on the flight path, network loading due to handover or overloading of UEs, or coverage holes may lead to suboptimal performance, inefficient utilization of network resources, and delays or failures of UAV UE operation. For example, while the height of operation and waypoints of a flight path may be chosen by a service provider based on UAV capabilities, permissions, or other criteria (e.g., traffic management, or government regulations, permissions, safety aspects like avoiding power lines), the flight path may provide sub-optimal or non-continuous coverage due to varying cellular capabilities in the RAN.

Aspects of the present disclosure generally relate to UAV flight path optimization. Some aspects more specifically relate to signaling of flight path information and optimization of the flight path information, or other configurations of a UAV UE or a network, based on radio conditions. Some aspects relate to determination of a reconfiguration of a network node or a UAV UE in view of an output of an AI/ML model.

In some aspects, a UE (e.g., UAV UE) may transmit flight path information regarding a flight path of the UE. The UE may receive, from a network node, a modification to the flight path information. For example, the modification may be associated with a radio condition, and the radio condition may be associated with the flight path. The UE may trigger movement of the UE (which may include reporting the modification to a UAV motion tracker). In some aspects, the radio condition may include a cellular coverage level of the flight path. In some aspects, the UE may request a certain radio condition, and the modification to the flight path may be in accordance with the requested radio condition.

In some aspects, a UE may receive a first configuration for a mobility operation. The UE may transmit flight path information regarding a flight path of the UE. The UE may receive, from a network node and in association with the flight path information, a second configuration for the mobility operation, where the second configuration is different than the first configuration. The UE may perform the mobility operation in accordance with the second configuration. In some aspects, the second configuration may be based on height information and a planning of cell coverage, such that the UE can be provided with a configuration that provides an optimal handover time conditional handover or lower-layer triggered mobility.

In some aspects, a network node may transmit a configuration associated with a mobility operation of a UE. The UE may be associated with a non-terrestrial network (NTN) or UAV. The configuration may be derived from a target cell type of the mobility operation. For example, the target cell type may indicate a cell size of a target cell of the mobility operation, whether the target cell is associated with the NTN or a terrestrial network, whether the target cell is a high-altitude platform station cell, or whether the target cell is an uncrewed aerial vehicle cell. In some aspects, the network node may generate the configuration based on a threshold number of mobility operations associated with a flight path of the UE.

In some aspects, an apparatus may receive input information regarding a RAN that provides coverage for a UAV UE. The input information may include at least one of minimization of drive test (MDT) reporting, self-organizing network (SON) reporting, or information regarding a radio condition of the RAN. The apparatus may obtain output information using an artificial intelligence or machine learning (AI/ML) model. The output information indicates a reconfiguration of at least one of a network node of the RAN, or the UAV UE. The network node may configure at least one of the network node or the UAV UE in accordance with the output information. For example, the network node may modify one or more parameters of a flight path the UAV UE, or may modify one or more cell parameters of the network node.

Aspects of the present disclosure may be used to realize one or more of the following possible advantages.

In some aspects, by modifying the flight path information in association with the radio condition, the network node may configure the UE to follow a flight path associated with a better radio condition than the unmodified flight path, thereby improving coverage and throughput. For example, by defining the radio condition to include a cellular coverage level, the network node can optimize cellular coverage on the (modified) flight path. By configuring the modification in accordance with the requested radio condition, the network node can provide coverage that satisfies a quality-of-service metric, a parameter (such as frequency range, subcarrier spacing, or power headroom) desired by the UE, or a combination thereof.

In some aspects, by providing a second configuration for a mobility operation in association with flight path information, the network node can reduce a number of handovers, improve efficiency of handover, or ensure that a UE is handed over to an appropriate cell while traversing a given flight path. Thus, the UE can be provided with a configuration that provides an optimal handover time conditional handover or lower-layer triggered mobility.

In some aspects, by providing a configuration (e.g., a handover criterion or a cell reselection criterion) derived from a target cell type of the mobility operation, the network node can configure the UE to perform mobility to a target cell in a fashion that reduces a number of handovers (thereby reducing overhead and delay) or avoids zones having lower than a threshold coverage. For example, configuring the UE in view of the target cell type (which may indicate a cell size of a target cell of the mobility operation, whether the target cell is associated with the NTN or a terrestrial network, whether the target cell is a high-altitude platform station cell, or whether the target cell is an uncrewed aerial vehicle cell) may enable the network node to cause mobility operations to various types of target cells, thereby ensuring coverage with a minimized number of handovers and avoiding blackout zones.

In some aspects, generating output information using an AI/ML model may provide improved scalability, parallel processing capability, and dynamic response to dynamically changing network conditions. For example, the AI/ML model may accept continuous inputs via reporting from the UE or the network node, and may accept information regarding a current network configuration. The AI/ML model may output reconfigurations of UEs or network nodes based on these inputs, which may enable reconfiguration of the RAN or the UE on a time scale and granularity unachievable by other means.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

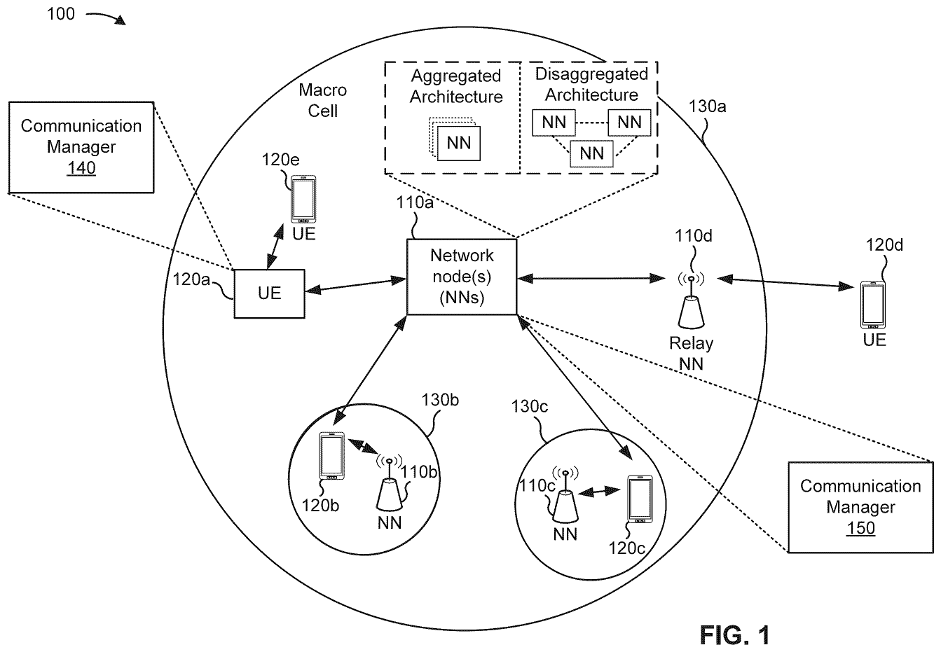

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular radio access technology (RAT) (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a non-terrestrial network (NTN) network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an extended reality (XR) device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of ultra-reliable low-latency communication (URLLC), enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some radio access technologies (RATs) may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may transmit flight path information regarding a flight path of the UE; receive a modification to the flight path information, wherein the modification is associated with a radio condition, wherein the radio condition is associated with the flight path; and trigger movement of the UE in association with the modification to the flight path information. Additionally, or alternatively, the communication manager 140 may perform one or more other operations described herein.

In some aspects, the UE 120 may include a communication manager 140. As described in more detail elsewhere herein, the communication manager 140 may receive a first configuration for a mobility operation; transmit flight path information regarding a flight path of the UE; receive, in association with the flight path information, a second configuration for the mobility operation; and perform the mobility operation in accordance with the second configuration. Additionally, or alternatively, the communication manager 140 may perform one or more other operations described herein.

In some aspects, the network node 110 may include a communication manager 150. As described in more detail elsewhere herein, the communication manager 150 may transmit a configuration associated with a mobility operation of a UE, wherein the UE is associated with a UAV, and wherein the configuration is derived from a target cell type of the mobility operation; and communicate for the mobility operation in accordance with the configuration. Additionally, or alternatively, the communication manager 150 may perform one or more other operations described herein.

In some aspects, the network node 110 may include a communication manager 150. As described in more detail elsewhere herein, the communication manager 150 may receive input information regarding a RAN that provides coverage for an UAV UE, wherein the input information includes at least one of MDT reporting, SON reporting, or information regarding a radio condition of the RAN; obtain output information using an AI/ML model and the input information, wherein the output information indicates a reconfiguration of at least one of: a network node of the RAN, or the UAV UE; and configure at least one of the network node or the UAV UE in accordance with the output information. Additionally, or alternatively, the communication manager 150 may perform one or more other operations described herein.

In some aspects, the network node 110 may include a communication manager 150. As described in more detail elsewhere herein, the communication manager 150 may receive flight path information regarding a flight path of a UE; and transmit, in association with a radio condition associated with the flight path, a modification to the flight path information. Additionally, or alternatively, the communication manager 150 may perform one or more other operations described herein.

In some aspects, the UE 120 may include a communication manager 140. As described in more detail elsewhere herein, the communication manager 140 may receive a first configuration for a mobility operation; transmit flight path information regarding a flight path of the UE; receive, in association with the flight path information, a second configuration for the mobility operation; and perform the mobility operation in accordance with the second configuration. Additionally, or alternatively, the communication manager 140 may perform one or more other operations described herein.

As indicated above, FIG. 1 is provided as an example. Other examples may differ from what is described with regard to FIG. 1.

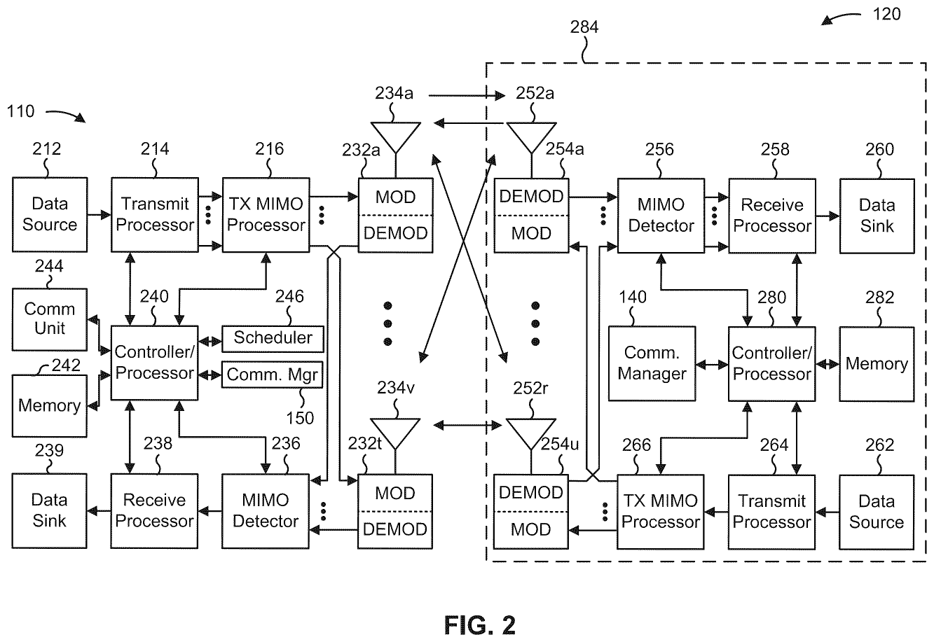

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a channel quality indicator (CQI) parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink SRS, and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

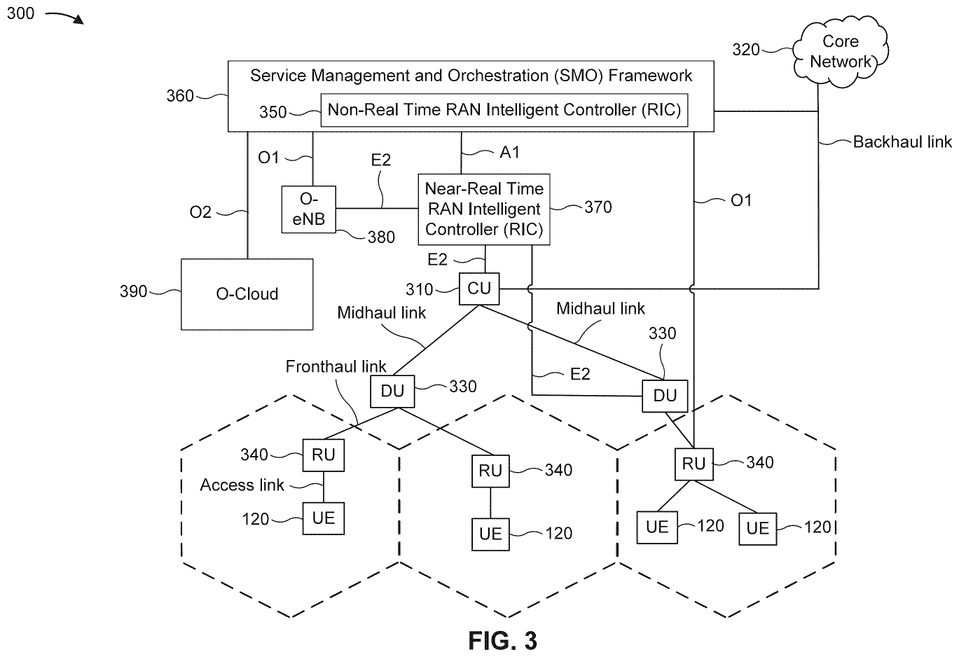

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O 1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, artificial intelligence and/or machine learning (AI/ML) workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

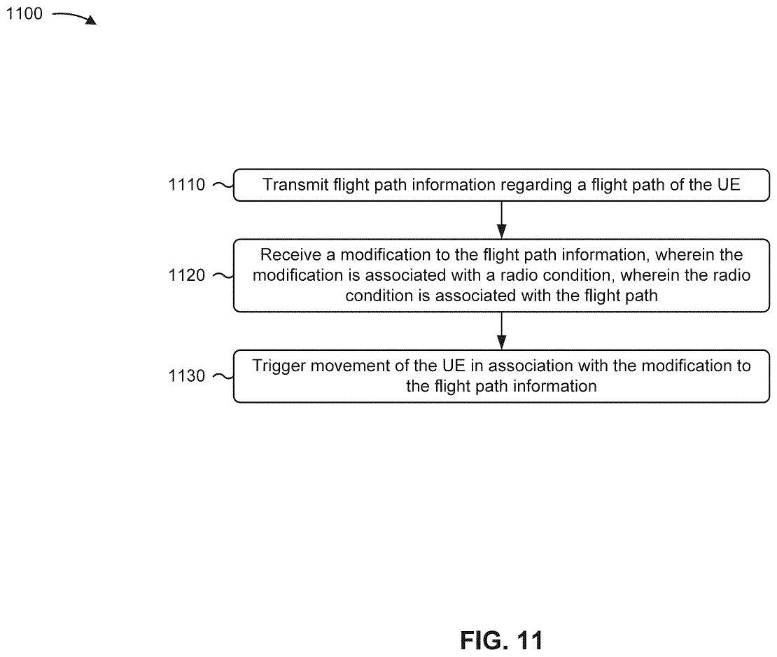

The network node 110, the controller/processor 240 of the network node 110, the UE 120, the controller/processor 280 of the UE 120, the CU 310, the DU 330, the RU 340, or any other component(s) of FIGS. 1, 2, or 3 may implement one or more techniques or perform one or more operations associated with UAV UEs, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, the processes of FIGS. 11-16, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform the processes of FIGS. 11-16, or other processes as described herein. In some examples, executing instructions may include running the instructions, converting the instructions, compiling the instructions, and/or interpreting the instructions, among other examples.

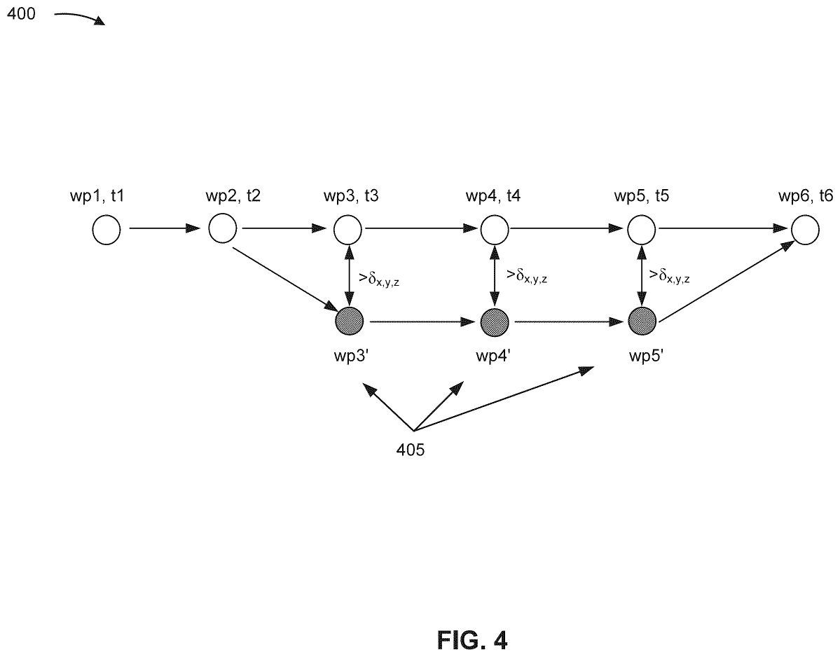

FIG. 4 is a diagram illustrating an example 400 of flight path information associated with a flight path, in accordance with the present disclosure. Example 400 illustrates a series of waypoints (labeled wp1, wp2, wp3, wp4, wp5, and wp6). Each waypoint is associated with a respective time (denoted t1 through t6). The series of waypoints and the times may define or otherwise be based on a flight path. A UE 120 (e.g., a UAV UE associated with a UAV) may move along the flight path. The UE 120 may transmit flight path information that identifies the flight path. For example, the flight path information may indicate the waypoints (e.g., via coordinate information or other location information), the times, or other information defining the flight path.

In some aspects, a UE 120 may report flight path information based on a deviation from a flight path. A deviation from a flight path is illustrated by reference number 405. In this example, the UE 120 deviates from the flight path defined by the series of waypoints by at least a threshold distance (δ_{x,y,z}). Thus, the UE 120 may report one or more updated waypoints or modifications to the flight path information (e.g., wp3′, wp4′, and wp5′).

As indicated above, FIG. 4 is provided as an example. Other examples may differ from what is described with regard to FIG. 4.

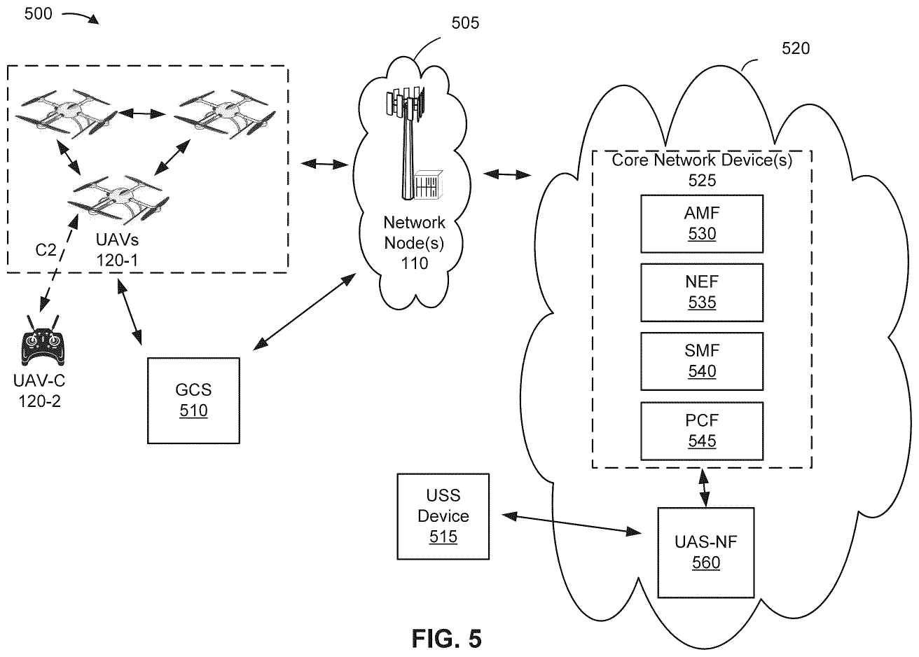

FIG. 5 is a diagram illustrating an example of UAV UEs 120 within a wireless communication network environment 500, in accordance with the present disclosure. As shown in FIG. 5, the environment 500 can include one or more UEs 120, which may include one or more UAVs 120-1 and one or more UAV controllers (UAV-Cs) 120-2, a RAN 505, a core network 520, a UAV service supplier (USS) device 515, and a ground control system (GCS) 510. Devices of environment 500 can interconnect via wired connections, wireless connections, or a combination of wired and wireless connections.

The UAV 120-1 (also referred to herein as a UAV UE 120-1) may include an aircraft without a human pilot aboard and can also be referred to as an unmanned aircraft (UA), a remotely piloted vehicle (RPV), a remotely piloted aircraft (RPA), a remotely operated aircraft (ROA), or an uncrewed aerial vehicle. The UAV 120-1 may have a variety of shapes, sizes, configurations, characteristics, or the like for a variety of purposes and applications. In some examples, the UAV 120-1 may include one or more sensors, such as an electromagnetic spectrum sensor (e.g., a visual spectrum, infrared, or near infrared camera, a radar system, or the like), a biological sensor, a temperature sensor, and/or a chemical sensor, among other examples. In some examples, the UAV 120-1 may include one or more components for communicating with one or more network nodes 110. Additionally, or alternatively, the UAV 120-1 may transmit information to and/or receive information from the GCS 510, such as sensor data, flight plan information, or the like. Such information can be communicated directly (e.g., via an RRC signal and/or the like) and/or via the network node(s) 110 on the RAN 505. The UAV 120-1 may be a component of an unmanned aircraft system (UAS). The UAS may include the UAV 120-1, a UAV-C 120-2 (also referred to herein as a UAV-C UE 120-2), and a system of communication (such as wireless communication network environment 500 or another system of communication) between the UAV 120-1 and the UAV-C 120-2.

The RAN 505 may include one or more network nodes 110 that provide access for the UAV UEs 120 to the core network 520. For example, the RAN 505 may include one or more aggregated network nodes and/or one or more disaggregated network nodes (e.g., including one or more CUs, one or more DUs, and/or one or more RUs). The UAV 120-1 may communicate with the network nodes 110 via the Uu interface. For example, the UAV 120-1 may transmit communications to a network node 110 and/or receive communications from the network node 110 via the Uu interface. Such Uu connectivity may be used to support different applications for the UAV 120-1, such as video transmission from the UAV 120-1 or C2 communications for remote command and control of the UAV 120-1, among other examples.

The GCS 510 may include one or more devices capable of managing the UAV 120-1 and/or flight plans for the UAV 120-1. For example, the GCS 510 may include a server device, a desktop computer, a laptop computer, or a similar device. In some examples, the GCS 510 may communicate with one or more devices of the environment 500 (e.g., the UAV 120-1, the USS device 515, and/or the like) to receive information regarding flight plans for the UAV UEs 120-1 and/or to provide recommendations associated with such flight plans, as described elsewhere herein. In some examples, the GCS 510 may permit a user to control one or more of the UAVs 120-1 (e.g., via the UAV-C 120-2). Additionally, or alternatively, the GCS 510 can use a neural network and/or other artificial intelligence (AI) to control one or more of the UAVs 120-1. In some examples, the GCS 510 may be included in a data center, a cloud computing environment, a server farm, or the like, which may include multiple GCSs 510. While shown as being external from the core network 520 in FIG. 5, in some aspects, the GCS 510 may reside at least partially within the core network 520.

The USS device 515 includes one or more devices capable of receiving, storing, processing, and/or providing information associated with the UAV UEs 120 and/or the GCS 510. For example, the USS device 515 can include an application server, a desktop computer, a laptop computer, a tablet computer, a mobile phone, or a similar device. In some examples, the UAVs 120-1 can interact with the USS device 515 to register a flight plan, receive approval, analysis, and/or recommendations related to a flight plan, or the like. The USS device 515 may register the UAV UE 120 with the USS device 515 by assigning an application-level UAV identifier to the UAV UE 120. The application-level UAV identifier may be an aviation administration (e.g., a regulatory body that governs aviation operation in a jurisdiction in which the USS device 515 and the UAV UE 120 are operating) UAV identifier.

The core network 520 includes a network that enables communications between the RAN 505 (e.g., the network node(s) 110) and one or more devices and/or networks connected to the core network 520. For example, the core network 520 may be a 5G core network. The core network 520 may include one or more core network devices 525, such as one or more access and mobility management functions (AMFs) (hereinafter referred to as an “AMF” 530), one or more network exposure functions (NEFs) hereinafter referred to as an “NEF” 535), one or more session management functions (SMFs) (hereinafter referred to as an “SMF” 540), one or more policy control functions (PCFs) (hereinafter referred to as a “PCF” 545), and/or other entities and/or functions that provide mobility functions for the UAV UEs 120 and enable the UAV UEs 120 to communicate with other devices of the environment 500.

The AMF 530 may include one or more network devices, such as one or more server devices, capable of managing authentication, activation, deactivation, and/or mobility functions associated with the UAV UE 120 connected to the core network 520. In some examples, the AMF 530 may perform operations relating to authentication of the UAV 120-1. The AMF 530 may maintain a non-access stratum (NAS) signaling connection with the UAV 120-1.

The NEF 535 may include one or more network exposure devices, such as one or more server devices, capable of exposing capabilities, events, information, or the like in one or more wireless networks to help other devices in the one or more wireless networks discover network services and/or utilize network resources efficiently. In some examples, the NEF 535 may receive traffic from and/or send traffic to the UAV 120-1 via the AMF 530 and the network node 110, and the NEF 535 may receive traffic from and/or send traffic to the USS device 515 via a UAS network function (UAS-NF) 560. In some examples, the NEF 535 may obtain a data structure, such as approval of a flight plan for the UAV 120-1, from the USS device 515 and divide the data structure into a plurality of data segments. In some examples, the NEF 535 may determine a location and/or reachability of the UAV 120-1 and/or a communication capability of the network node 110 to determine how to send the plurality of data segments to the UAV 120-1.

The SMF 540 may include one or more network devices, such as one or more server devices, capable of managing sessions for the RAN 505 and allocating addresses, such as Internet protocol (IP) addresses, to the UAVs 120-1. In some examples, the SMF 540 may perform operations relating to registration of the UAV 120-1. For example, the AMF 530 may receive a registration request from the UAV 120-1 and forward a request to the SMF 540 to create a corresponding packet data unit (PDU) session. The SMF 540 may allocate an address to the UAV 120-1 and establish the PDU session for the AMF 530.

The PCF 545 may include one or more network devices, such as one or more server devices, capable of managing traffic to and from the UAV UEs 120 through the RAN 505 and enforcing a QoS on the RAN 505. In some examples, the PCF 545 may implement charging rules and flow control rules, manage traffic priority, and/or manage a QoS for the UAVs 120-1.

The USS device 515 may communicate with the core network 520 using the UAS-NF 560. The UAS-NF 560 may be a service-based interface to enable the USS device 515 to provide information to the core network 520. For example, the USS device 515 may provide, via the UAS-NF 560, registration information associated with a registration between the UAV 120-1 and the USS device 515. The UAS-NF 560 may include a device, such as a server device, that is external to the core network 520, or the UAS-NF 560 may reside, at least partially, on a core network device 525 within the core network 520. In some aspects, the UAS-NF 560 may be co-located with the NEF 535.

The UAV-C 120-2 may remotely control the UAV 120-2 by transmitting C2 communications to the UAV 120-1 and/or receiving C2 communications from the UAV 120-1. In some examples, the UAV-C 120-2 and the UAV 120-1 may use the Uu interface for the C2 communications. For example, the UAV-C 120-2 may transmit C2 communications to UAV 120-1 (and receive C2 communications from the UAV 120-1) via the network node 110. In some examples, the UAV-C 120-2 and the UAV 120-1 may use a non-cellular communication system (e.g., non-3GPP connectivity), such as wireless fidelity (Wi-Fi), for the C2 communications. Currently, NR, in the specification promulgated by 3GPP, does not support transmission of C2 communications via the PC5 interface. However, in some cases, the UAV-C 120-2 may be capable of communicating via the PC5 interface, but may not have Uu capability. Furthermore, because PC5 can cover a longer distance than Wi-Fi, transmission of C2 communications via PC5 unicast communications may result in an increased range of the C2 communications, as compared with Wi-Fi. In addition, transmission of C2 communications via PC5 unicast communications (e.g., via a PC5 direct link between the UAV 120-1 and the UAV-C 120-2) may result in decreased latency, as compared with C2 communications transmitted via the network node 110 using the Uu interface.

As indicated above, FIG. 5 is provided as an example. Other examples may differ from what is described with respect to FIG. 5.

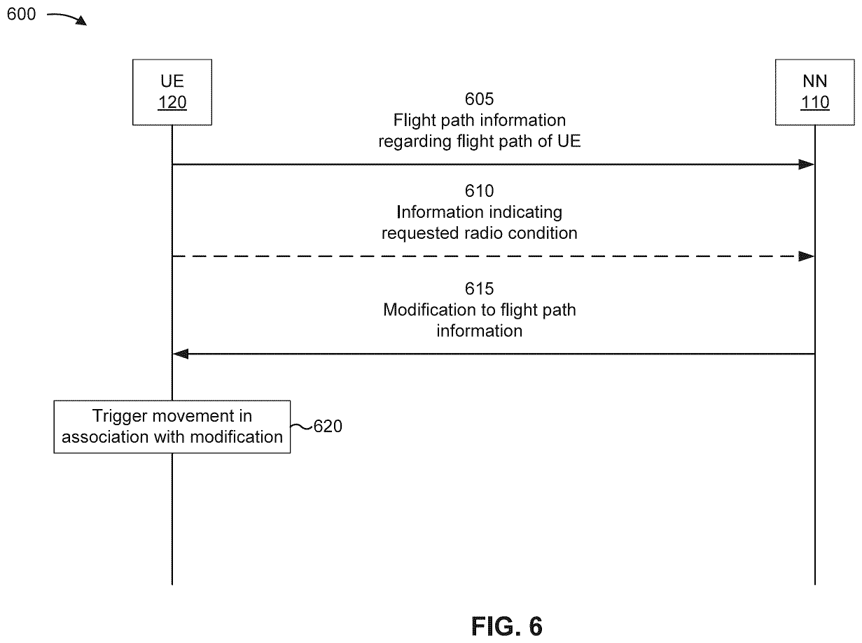

FIG. 6 is a diagram illustrating an example 600 of signaling for modification of a UE's flight path, in accordance with the present disclosure. Example 600 includes a UE 120 (e.g., a UAV UE) and a network node 110 (e.g., RAN 505).

As shown in FIG. 6, and by reference number 605, the UE 120 may transmit, and the network node 110 may receive, flight path information regarding a flight path of the UE 120. The flight path information may include information indicating one or more waypoints of the flight path, time information corresponding to the one or more waypoints, or the like, as described with regard to FIG. 4. In some aspects, the network node 110 may receive at least part of the flight path information from an entity other than the UE 120, such as an OEM or service provider associated with the UE 120.

As shown by reference number 610, in some aspects, the UE 120 may transmit information indicating a requested radio condition. For example, the information indicating the requested radio condition may include an indication of a quality-of-service (QoS) parameter (such as a desired throughput, a desired block error rate (BLER), a desired latency, or a combination thereof). In some aspects, the QoS parameter relate to an application level of the UE. For example, the QoS parameter may indicate a QoS requirement relating to an application of the UE 120. Additionally, or alternatively, the information indicating the requested radio condition may include an indication of a cell parameter (such as an indication of a frequency range such as a sub-6 GHz frequency range or a FR2 frequency range, a subcarrier spacing, a power headroom (PHR) value, or a combination thereof), which may be referred to as a radio parameter. In some aspects, the UE 120 may transmit the information indicating the requested radio condition via UE assistance information or another form of signaling (e.g., Layer 2 signaling). Thus, the UE 120 may signal information indicating desired parameters (which may vary depending on the application of the UAV).

As shown by reference number 615, the network node 110 may transmit, and the UE 120 may receive, a modification to the flight path information. For example, the network node 110 may transmit information indicating the modification via RRC signaling (such as an RRC reconfiguration message), system information block (SIB) broadcast (e.g., for group handling), C2 signaling, or the like. In some aspects, the modification may modify a flight path defined by the flight path information. For example, the modification may change a location of a waypoint of the flight path. As another example, the modification may add a waypoint to the flight path (such as to route the UE 120 or the UAV through an area having a satisfactory coverage). As another example, the modification may remove a waypoint from the flight path (such as to cause the UE 120 to avoid an area having unsatisfactory coverage). As another example, the modification may indicate a change to an altitude of operation of the UE 120. For example, the modification may indicate for the UE to move from a first altitude (e.g., H1) to a modified altitude (e.g., H1 minus delta), which may improve coverage. For example, the modification may include a command to move to a different height.

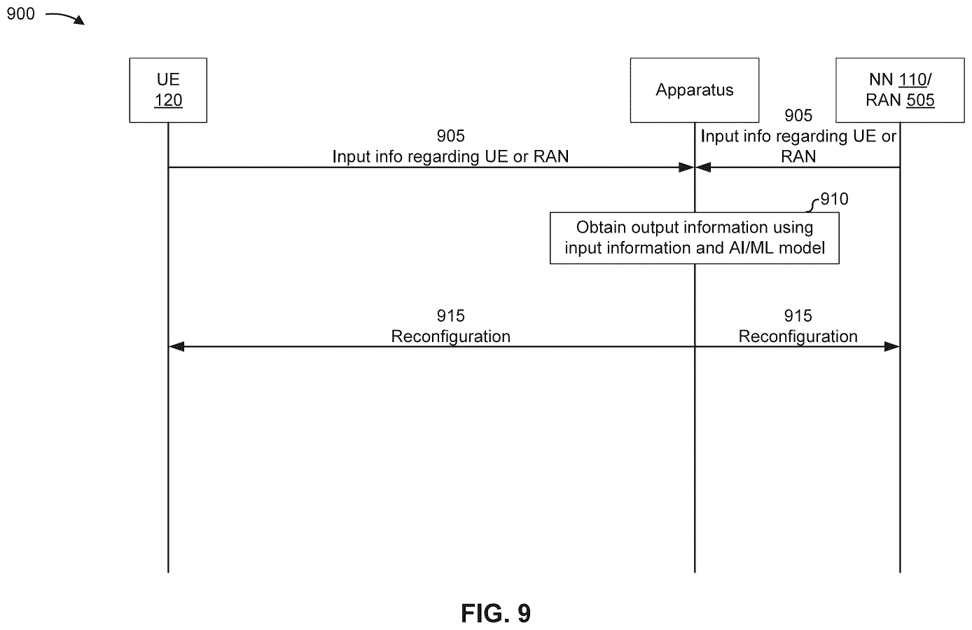

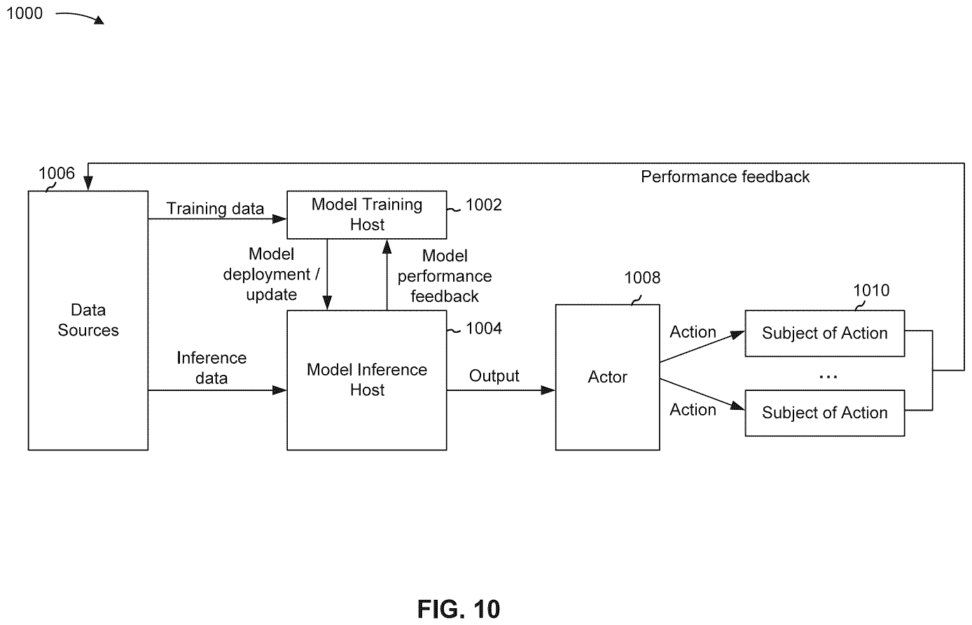

In some aspects, the modification to the flight path information may be based on an AI/ML model. For example, the network node 110 may generate the modification to the flight path information based on output information from an AI/ML model, as described with regard to FIGS. 9 and 10. As another example, the network node 110 may receive the configuration as generated by an AI/ML model, as described with regard to FIGS. 9 and 10.

In some aspects, the network node 110 may reconfigure itself or another network node 110 based on the flight path information or the requested radio condition. For example, the network node 110 may reconfigure a scheduling pattern of one or more cells so that a QoS parameter or cell parameter requested by the UE 120 is satisfied. As another example, the network node 110 may activate or deactivate one or more BWPs, component carriers, or cells (such as to add bandwidth to the network) so that the QoS parameter or the cell parameter is satisfied. As another example, the network node 110 may modify a beam width of a beam generated by the network node 110, or may add a beam or change a number of beams, such as to improve coverage of the flight path or the modification to the flight path of the UE 120.

In some aspects, the UE 120 may negotiate the modification to the flight path information. For example, the UE 120 may receive a first modification to the flight path information. In some aspects, this first modification may be unsuitable for the UE 120. For example, the first modification may modify the flight path such that the UE 120 is caused to exceed a remaining flight time of the UAV, a battery life of the UE 120 or the UAV, or the like. In some aspects, the UE 120 may transmit a negotiation message indicating a change associated with the first modification. For example, the UE 120 may provide an indication of the battery life or remaining flight time. As another example, the UE 120 may provide a modification of a waypoint or time, such as a waypoint or time modified by the first modification. In some aspects, the network node 110 may transmit a second modification after receiving the negotiation message. For example, the network node 110 may modify the flight path as indicated by the negotiation message. As another example, the network node 110 may modify the flight path based on the negotiation message (e.g., by modifying the flight path to avoid an area indicated as unreachable due to the UE 120's remaining flight time).

As shown by reference number 620, the UE 120 may trigger movement of the UE 120 in association with the modification to the flight path information. For example, the UE 120 may control a corresponding UAV to implement the flight path in accordance with the modification to the flight path information. As another example, the UE 120 may provide the modification to the flight path information (or an indication of an updated flight path in accordance with the modification) to a UAV motion tracker (e.g., a Global Positioning System (GPS) assisted UAV motion tracker). For example, the UE 120 may update route information of the UAV, and may provide the updated route information to the UAV motion tracker. The UAV motion tracker may include a component (at the UAV or remote from the UAV) that tracks and/or controls motion of the UAV. For example, the UAV motion tracker may provide instructions to control the motion of the UAV. As another example, the UAV motion tracker may track motion of the UAV, and may determine whether the UAV has deviated from a flight path by a threshold amount, as described in connection with FIG. 4.

As indicated above, FIG. 6 is provided as an example. Other examples may differ from what is described with regard to FIG. 6.

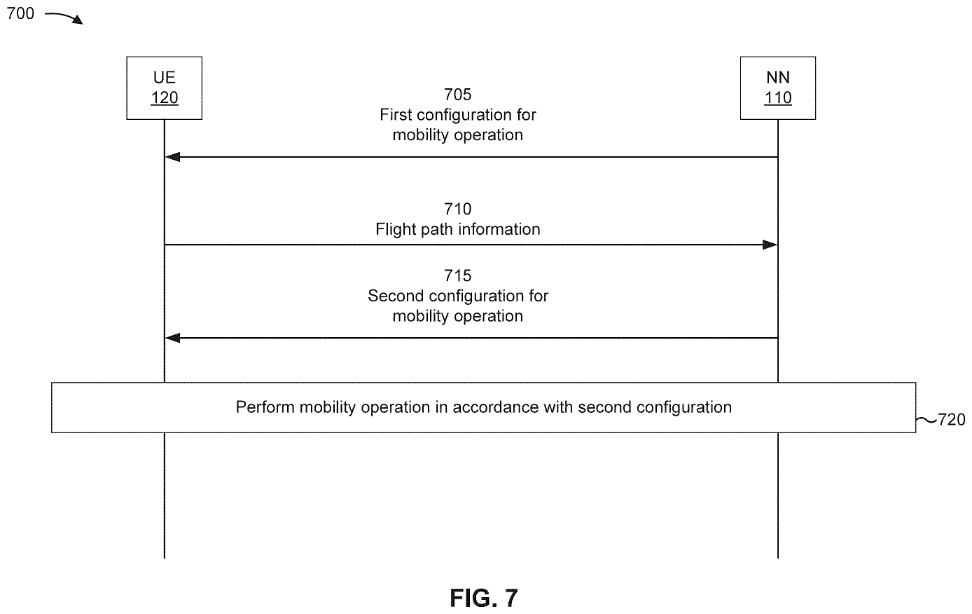

FIG. 7 is a diagram illustrating an example 700 of signaling for modification of a UE's flight path, in accordance with the present disclosure. Example 700 includes a UE 120 (e.g., a UAV UE) and a network node 110 (e.g., RAN 505).

As shown by reference number 705, the network node 110 may transmit, and the UE 120 may receive, a first configuration for a mobility operation. In some aspects, the mobility operation may include a conditional handover (sometimes abbreviated “CHO”). In a conditional handover, a UE 120 may determine to perform a handover when certain conditions are satisfied. In other words, the UE 120 may execute the conditional handover when the certain conditions (configured via the first configuration) are satisfied. The UE 120 may start evaluating execution condition(s) after receiving a conditional handover configuration (e.g., the first configuration) from the source network node 110a. The UE 120 may stop evaluating the execution condition(s) after the conditional handover is executed. A conditional handover may differ from a traditional handover in that a traditional handover may be directly triggered by the network in response to a measurement report from the UE 120, whereas a conditional handover may be triggered by certain conditions being satisfied, which reduces overhead and latency associated with handover. In the context of a UAV UE, conditions for CHO may include a height condition (e.g., H1, H2, a hysteresis value for a height condition).

In some aspects, the mobility operation may include a lower-layer triggered mobility (LTM) operation. In an LTM operation, a UE 120 may be configured (via the first configuration) with a number of candidate cells. Mobility to these candidate cells may be triggered via dynamic signaling, which differs from traditional handover in that traditional handover signaling is typically handled via semi-static (e.g., RRC) signaling.

As shown by reference number 710, the UE 120 may transmit, and the network node 110 may receive, flight path information regarding a flight path of the UE 120. The transmission of the flight path information is described in more detail in connection with FIG. 6. The transmission of the flight path information can include any of the transmissions or information described with regard to flight path information transmission in FIG. 6.

As shown by reference number 715, the network node 110 may transmit, and the UE 120 may receive, a second configuration for the mobility operation. The second configuration may be associated with the flight path information. For example, the network node 110 may generate the second configuration using the flight path information. More particularly, the network node 110 may reconfigure a CHO (such as one or more conditions of the CHO) according to an altitude or location of the UE 120 in order to improve execution of CHO (e.g., to optimize handover time for a seamless CHO execution). In this example, the CHO may be configured such that the UE 120 moves to cells on a flight path of the UE sufficiently early to ensure radio connectivity along waypoints identified by the flight path information. As another example, the network node 110 may configure one or more candidate cells for an LTM operation to improve coverage of the UE 120. In some aspects, the second configuration may indicate one or more updated values of one or more parameters of the first configuration. In some aspects, the network node 110 may generate or provide the second configuration based on flight paths of multiple UEs. For example, multiple UEs may report flight paths to the network node 110, and the network node 110 may update a CHO condition (specific to a particular UE or for the multiple UEs) or reconfigure an LTM operation based on the flight paths of the multiple UEs. For example, the network node 110 may update the CHO condition or reconfigure the LTM operation such that UEs are effectively load-balanced between cells, such that the UEs are adequately covered by one or more cells or beams, or the like.

In some aspects, the second configuration may be based on an AI/ML model. For example, the network node 110 may generate the second configuration based on output information from an AI/ML model, as described with regard to FIGS. 9 and 10. As another example, the network node 110 may receive the second configuration as generated by an AI/ML model, as described with regard to FIGS. 9 and 10.

As shown by reference number 720, the UE 120 and/or the network node 110 perform the mobility operation in accordance with the second configuration. For example, the UE 120 may update one or more CHO conditions according to the second configuration and/or may perform a CHO in accordance with the one or more CHO conditions being satisfied. As another example, the UE 120 may update an LTM operation (e.g., one or more candidate cells, etc.) in accordance with the second configuration, and/or may perform an LTM operation in accordance with the second configuration.

As indicated above, FIG. 7 is provided as an example. Other examples may differ from what is described with regard to FIG. 7.

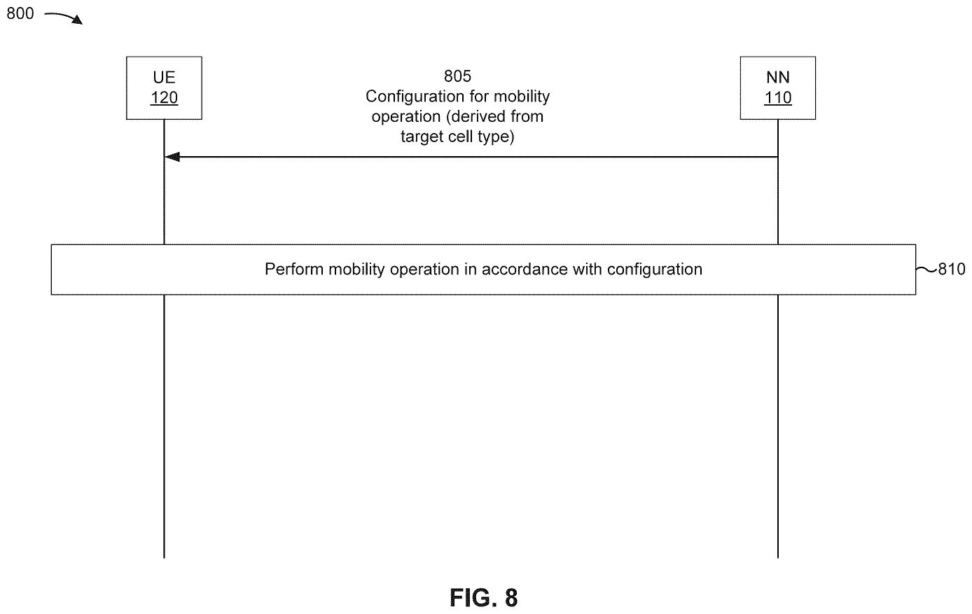

FIG. 8 is a diagram illustrating an example 800 of signaling for mobility associated with a target cell type, in accordance with the present disclosure. Example 800 includes a UE 120 (e.g., a UAV UE) and a network node 110 (e.g., RAN 505).

A target cell type may indicate a type of cell that a UE 120 is to switch to when performing a mobility operation. For example, a target cell type may indicate a cell size of a target cell (e.g., a macro cell, a micro cell, or another size of cell described herein). As another example, a target cell type may indicate whether a target cell is part of an NTN or a terrestrial network (TN). In some aspects, an NTN cell may be a macro cell, and a TN cell may be a micro cell. In some aspects, a macro cell may provide a wider coverage area thana micro cell, whereas a micro cell may provide higher capacity than a macro cell. As another example, a target cell type may indicate whether a target cell is a high-altitude platform station (HAPS) cell (that is, a cell provided by a network node associated with a HAPS or a UAV).

Configuring a mobility operation associated with a target cell type may provide for a UE 120 to be switched to a target cell having the target cell type. This may enable the network node 110 to address insufficient coverage or to fine-tune handover of the UE 120. For example, the network node 110 may configure the UE 120 to switch to a cell having a macro cell target cell type (or an NTN target cell type) before the UE 120 reaches a zone with lower than a threshold coverage (such as a blackout zone, which may be due to a geographical feature or a regulatory restriction such as a military or aviation restriction). As another example, the network node 110 may configure the UE 120 to switch to a target cell having a particular cell type (such as a macro cell or an NTN cell) to reduce a number of handovers in a given area. As another example, the network node 110 may configure the UE 120 to switch to a TN target cell type to provide a threshold performance (e.g., a higher bandwidth, a higher throughput).

As shown by reference number 805, the network node 110 may generate and/or transmit, and the UE 120 may receive, a configuration for a mobility operation. For example, the configuration for the mobility operation may indicate one or more thresholds for the mobility operation, such as a measurement reporting threshold, a cell selection criterion, a handover criterion, a CHO condition, a cell reselection criterion, or a combination thereof. The configuration may be derived from a target cell type of the mobility operation. For example, the network node 110 may identify a target cell type for the mobility operation. The network node 110 may configure the mobility operation such that the UE 120 selects a target cell of the target cell type. For example, the network node 110 may indicate a change in a handover criterion or a CHO condition of a cell such that the UE 120 is likely to select a target cell of the target cell type. As another example, the network node 110 may configure the UE 120 with a flag that enables selection of cells of a particular target cell type (e.g., enabling NTN communication).

In some aspects, the target cell type may be a macro cell. For example, the network node 110 may configure the UE 120 to select a macro cell when the UE is associated with a slow movement speed and/or a low capacity (e.g., throughput, bandwidth) requirement. As another example, the network node 110 may configure the UE 120 to select a micro cell when the UE is associated with a slow movement speed and/or a high capacity (e.g., throughput, bandwidth) requirement. As another example, the network node 110 may configure the UE 120 to select a macro cell when the UE is associated with a fast movement speed.

In some aspects, the target cell may be an NTN cell (e.g., a cell of an NTN). For example, the network node 110 may configure the UE 120 to select an NTN cell when the UE 120 is associated with a rapidly changing height (e.g., a height with a rate of change greater than a threshold) or a height that exceeds TN coverage.

Thus, the network node 110 may configure the UE 120 to maintain a connection and satisfy throughput needs, which may be different for different UEs 120.

In some aspects, the configuration may be based on an AI/ML model. For example, the network node 110 may generate the configuration based on output information from an AI/ML model, as described with regard to FIGS. 9 and 10. As another example, the network node 110 may receive the configuration as generated by an AI/ML model, as described with regard to FIGS. 9 and 10.

As shown by reference number 810, the UE 120 and/or the network node 110 perform the mobility operation in accordance with the configuration. For example, the UE 120 may update handover or cell selection criteria in accordance with the configuration for the mobility operation. In some aspects, the UE 120 may transmit a measurement report in accordance with a handover criterion of the configuration, and the network node 110 (or another network node 110) may trigger a handover in association with the measurement report. In some aspects, the UE 120 may perform a CHO in accordance with a CHO condition of the configuration.

As indicated above, FIG. 8 is provided as an example. Other examples may differ from what is described with regard to FIG. 8.

FIG. 9 is a diagram illustrating an example 900 of signaling for AI/ML based configuration of a RAN or UAV UE, in accordance with the present disclosure. Example 900 includes a UE 120 and an apparatus. The apparatus may include, for example, a network node 110, a SON entity, a RIC (e.g., a near-RT RIC 370, a non-RT RIC 350), an AI/ML server, an entity of a core network (e.g., core network 520), or the like. In some aspects, the apparatus may communicate directly with the UE 120. In some other aspects, the apparatus may communicate with the UE 120 via one or more nodes such as a network node 110. Example 900 also includes a RAN 505, which may include one or more network nodes 110.

As shown in FIG. 9, and by reference number 905, the apparatus may receive input information regarding the UE 120 or the RAN 505. As mentioned in connection with FIG. 5, the RAN 505 may provide coverage for the UE 120, which is a UAV UE. In some aspects, the input information may include information gathered by the UE 120, such as a measurement report, a minimization of drive test (MDT) report, a self-organizing network (SON) report, location information indicating a location of the UE 120, or the like. In some aspects, the input information may include information gathered by the network node 110. For example, the input information may include a SON report generated by the network node 110. As another example, the input information may include information indicating a current configuration of the network node 110 (e.g., beam directions, beam strengths, a number of cells, a number of UEs served by the network node 110, coverage areas, scheduling information etc.). As another example, the input information may include information regarding a radio condition, such as a cellular coverage level (e.g., an RSRP, a RSRQ, a signal to interference plus noise ratio (SINR), a throughput, a number of UEs covered by a network node 110).

In some aspects, the input information may indicate a number of mobility operations of a flight path of the UE 120. For example, the input information may indicate a number of mobility operations (e.g., handovers) performed by a UE on a given flight path. This information may be used to reconfigure the UE 120 and/or the RAN 505 to minimize handover, as described below. In some aspects, the input information may indicate a zone having a coverage lower than a threshold (e.g., a blackout zone).

In some aspects, the apparatus may receive the input information continuously. For example, the UE 120 or the network node 110 may provide the input information periodically, in accordance with a reporting configuration, or the like. As another example, the UE 120 or the network node 110 may provide the input information according to a request for the input information. As another example, the UE 120 or the network node 110 may provide the input information upon a trigger condition being satisfied, such as a measurement being below a first threshold or a number of handovers being greater than a second threshold. As another example, the UE 120 or the network node 110 may provide the input information in response to a parameter of the input information changing.

As shown by reference number 910, the apparatus may obtain output information using the input information and an AI/ML model. For example, the apparatus may input the input information to the AI/ML model. The AI/ML model may output the output information. The output information may include, or may be used to generate, a reconfiguration of the network node 110 and/or a reconfiguration of the UE 120. For example, the reconfiguration may include any change or modification to a configuration of a UE 120 or a network node 110 described with regard to FIGS. 6-8, such as a modification to a flight path of the UE 120, a change to an altitude of operation of the UE 120, a change to one or more cell parameters of the network node 110 (such as a target cell type, a frequency range, a subcarrier spacing, or a power headroom), a modification of a parameter for a mobility operation (such as a CHO condition, a parameter or candidate cell of an LTM operation, or the like), or a combination thereof.

In some aspects, the output information may reduce (e.g., minimize, optimize) a number of mobility operations associated with a flight path. For example, the input information may indicate a number of mobility operations performed by UEs on the flight path. The AI/ML model may be configured to reconfigure a UE 120 or a network node 110 (e.g., according to techniques described elsewhere herein) such that the number of mobility operations along the flight path is reduced. Additionally, or alternatively, the output information may reconfigure a zone to have improved coverage. For example, the input information may indicates a zone, associated with a flight path of the UE, having a first coverage lower than a threshold coverage. The reconfiguration of the network node 110 or the UE 120 may be associated with a second coverage higher than the threshold coverage, such as by reconfiguring one or more network nodes to improve coverage (e.g., reorienting beams, changing beam width, switching to an NTN, etc.).

As shown by reference number 915, the apparatus may configure at least one of the network node or the UAV UE in accordance with the output information. For example, the apparatus may provide configuration information to the UE 120 to reconfigure the UE 120 as described above. As another example, the apparatus may provide configuration information to the network node 110 and/or one or more other nodes of the RAN 505 to reconfigure the network node 110 or RAN 505 as described as above.

As indicated above, FIG. 9 is provided as an example. Other examples may differ from what is described with regard to FIG. 9.

FIG. 10 is a diagram illustrating an example architecture 1000 of a functional framework for RAN intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (e.g., the AI functionality and/or the input/output of the component for AI enabled optimization) have been utilized or studied to identify the benefits of AI enabled RAN through possible use cases (e.g., beam management, energy saving, load balancing, mobility management, and/or coverage optimization, among other examples). In one example, as shown by the architecture 1000, a functional framework for RAN intelligence may include multiple logical entities, such as a model training host 1002, a model inference host 1004, data sources 1006, and an actor 1008.

The model inference host 1004 may be configured to run an AI/ML model (such as the AI/ML model of FIG. 9) based on inference data provided by the data sources 1006 (such as a UE 120 or a network node 110 described with regard to FIGS. 6-9), and the model inference host 1004 may produce an output (e.g., a prediction) with the inference data input to the actor 1008. The actor 1008 may be an element or an entity of a core network or a RAN. For example, the actor 1008 may be a UE, a network node, base station (e.g., a gNB), a CU, a DU, and/or an RU, a near-RT RIC, or a non-RT RIC, among other examples. In addition, the actor 1008 may also depend on the type of tasks performed by the model inference host 1004, type of inference data provided to the model inference host 1004, and/or type of output produced by the model inference host 1004. For example, if the output from the model inference host 1004 is associated with position determination, the actor 1008 may be a UE, a DU or an RU. In some examples, the model inference host 1004 may be hosted on the actor 1008. For example, a UE may be the actor 1008 and may host the model inference host 1004. In some aspects, a UE (e.g., the actor 1008) may be a data source 1006. For example, the UE may perform a measurement (e.g., an NR measurement), may input the measurement to the AI/ML model at the model inference host 1004 (or may provide the measurement to the model inference host 1004), and may act based on an output of the AI/ML model (e.g., by reconfiguring the UE 120 or the network node 110).

After the actor 1008 receives an output from the model inference host 1004, the actor 1008 may determine whether to act based on the output. For example, if the actor 1008 is a UE and the output from the model inference host 1004 is associated with position information, the actor 1008 may determine whether to report the position information, reconfigure a beam, among other examples. If the actor 1008 determines to act based on the output, in some examples, the actor 1008 may indicate the action to at least one subject of action 1010.

The data sources 1006 may also be configured for collecting data that is used as training data for training an ML model or as inference data for feeding an ML model inference operation. For example, the data sources 1006 may collect data from one or more core network and/or RAN entities, which may include the actor 1008 or the subject of action 1010, and provide the collected data to the model training host 1002 for ML model training. In some aspects, the model training host 1002 may be co-located with the model inference host 1004 and/or the actor 1008. For example, the actor 1008 or the subject of action 1010 may provide performance feedback associated with the beam configuration to the data sources 1006, where the performance feedback may be used by the model training host 1002 for monitoring or evaluating the ML model performance, such as whether the output (e.g., prediction) provided to the actor 1008 is accurate. In some examples, the model training host 1002 may monitor or evaluate ML model performance using a training position value, which may be provided by a node (e.g., a UE 120 or a network node 110), as described elsewhere herein. In some examples, if the output provided by the actor 1008 is inaccurate (or the accuracy is below an accuracy threshold), then the model training host 1002 may determine to modify or retrain the ML model used by the model inference host, such as via an ML model deployment/update.

As indicated above, FIG. 10 is provided as an example. Other examples may differ from what is described with regard to FIG. 10.

FIG. 11 is a diagram illustrating an example process 1100 performed, for example, at a UE or an apparatus of a UE, in accordance with the present disclosure. Example process 1100 is an example where the apparatus or the UE (e.g., UE 120) performs operations associated with uncrewed aerial vehicle flight path optimization.

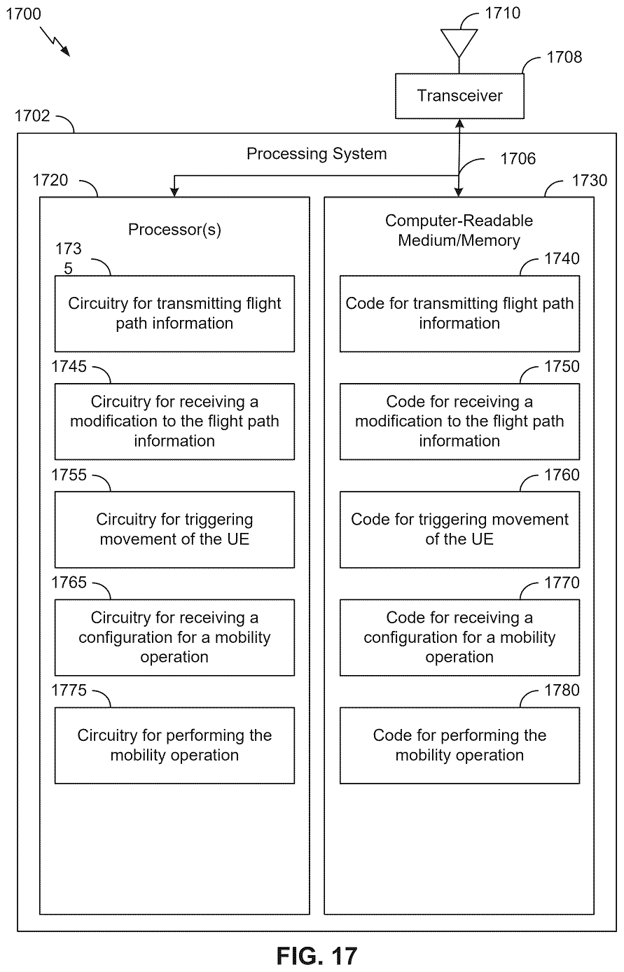

As shown in FIG. 11, in some aspects, process 1100 may include transmitting flight path information regarding a flight path of the UE (block 1110). For example, the UE (e.g., using transceiver 1708 and/or antenna 1710, depicted in FIG. 17) may transmit flight path information regarding a flight path of the UE, as described above.

As further shown in FIG. 11, in some aspects, process 1100 may include receiving a modification to the flight path information, wherein the modification is associated with a radio condition, wherein the radio condition is associated with the flight path (block 1120). For example, the UE (e.g., using transceiver 1708 or antenna 1710, depicted in FIG. 17) may receive a modification to the flight path information, wherein the modification is associated with a radio condition, wherein the radio condition is associated with the flight path, as described above.

As further shown in FIG. 11, in some aspects, process 1100 may include triggering movement of the UE in association with the modification to the flight path information (block 1130). For example, the UE (e.g., using transceiver 1708 and/or antenna 1710, depicted in FIG. 17) may trigger movement of the UE in association with the modification to the flight path information, as described above.

Process 1100 may include additional aspects, such as any single aspect or any combination of aspects described below and/or in connection with one or more other processes described elsewhere herein.

In a first aspect, the flight path information indicates a first waypoint of the flight path and a second waypoint of the flight path, and wherein the modification to the flight path information indicates at least one of a modification to one or more of the first waypoint or the second waypoint, or an additional waypoint for the flight path.

In a second aspect, alone or in combination with the first aspect, the modification to the flight path information indicates a change to an altitude of operation of the UE.

In a third aspect, alone or in combination with one or more of the first and second aspects, triggering movement in association with the modification to the flight path information comprises providing the modification to the flight path information to an UAV motion tracker.

In a fourth aspect, alone or in combination with one or more of the first through third aspects, the radio condition is a cellular coverage level of the flight path.

In a fifth aspect, alone or in combination with one or more of the first through fourth aspects, the method comprises receiving a first modification to the flight path, transmitting a negotiation message indicating a change associated with the first modification, and receiving a second modification to the flight path after transmitting the negotiation message, wherein the modification to the flight path is the second modification to the flight path information.

In a sixth aspect, alone or in combination with one or more of the first through fifth aspects, the change associated with the first modification is associated with at least one of a battery of the UE or a remaining flight time of the UE.

In a seventh aspect, alone or in combination with one or more of the first through sixth aspects, process 1100 includes transmitting information indicating a requested radio condition, wherein the requested radio condition includes at least one of a quality-of-service parameter or a cell parameter, and wherein receiving the modification to the flight path information comprises receiving the modification in accordance with the requested radio condition.

In an eighth aspect, alone or in combination with one or more of the first through seventh aspects, the quality-of-service parameter indicates at least one of a throughput, a block error rate, or a latency.

In a ninth aspect, alone or in combination with one or more of the first through eighth aspects, the cell parameter indicates at least one of a frequency range, a subcarrier spacing, or a power headroom.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

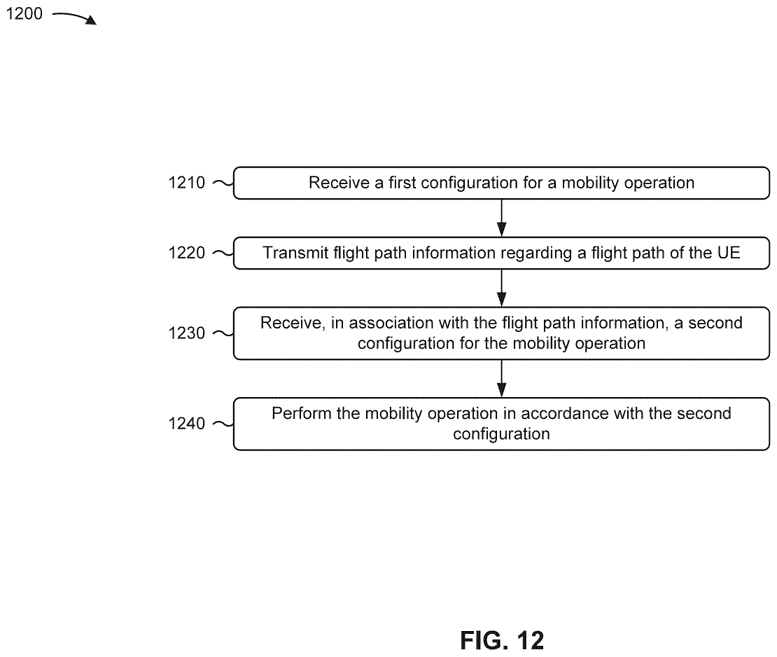

FIG. 12 is a diagram illustrating an example process 1200 performed, for example, at a UE or an apparatus of a UE, in accordance with the present disclosure. Example process 1200 is an example where the apparatus or the UE (e.g., UE 120) performs operations associated with uncrewed aerial vehicle flight path optimization.

As shown in FIG. 12, in some aspects, process 1200 may include receiving a first configuration for a mobility operation (block 1210). For example, the UE (e.g., using transceiver 1708 and/or antenna 1710, depicted in FIG. 17) may receive a first configuration for a mobility operation, as described above.

As further shown in FIG. 12, in some aspects, process 1200 may include transmitting flight path information regarding a flight path of the UE (block 1220). For example, the UE (e.g., using transceiver 1708 and/or antenna 1710, depicted in FIG. 17) may transmit flight path information regarding a flight path of the UE, as described above.

As further shown in FIG. 12, in some aspects, process 1200 may include receiving, in association with the flight path information, a second configuration for the mobility operation (block 1230). For example, the UE (e.g., using transceiver 1708 and/or antenna 1710, depicted in FIG. 17) may receive, in association with the flight path information, a second configuration for the mobility operation, as described above.

As further shown in FIG. 12, in some aspects, process 1200 may include performing the mobility operation in accordance with the second configuration (block 1240). For example, the UE (e.g., using transceiver 1708 and/or antenna 1710, depicted in FIG. 17) may perform the mobility operation in accordance with the second configuration, as described above.

Process 1200 may include additional aspects, such as any single aspect or any combination of aspects described below and/or in connection with one or more other processes described elsewhere herein.

In a first aspect, the mobility operation is a conditional handover and the second configuration for the mobility operation modifies at least one conditional handover parameter.

In a second aspect, alone or in combination with the first aspect, the at least one conditional handover parameter comprises a condition triggering the conditional handover.

In a third aspect, alone or in combination with one or more of the first and second aspects, the mobility operation is a lower-layer triggered mobility operation and the second configuration for the mobility operation modifies at least one parameter of the lower-layer triggered mobility operation.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

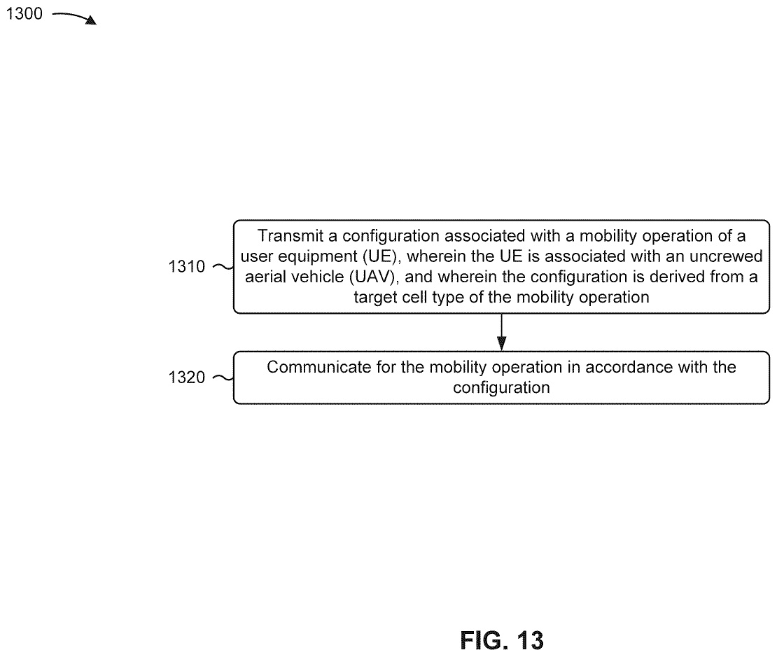

FIG. 13 is a diagram illustrating an example process 1300 performed, for example, at a network node or an apparatus of a network node, in accordance with the present disclosure. Example process 1300 is an example where the apparatus or the network node (e.g., network node 110) performs operations associated with uncrewed aerial vehicle flight path optimization.

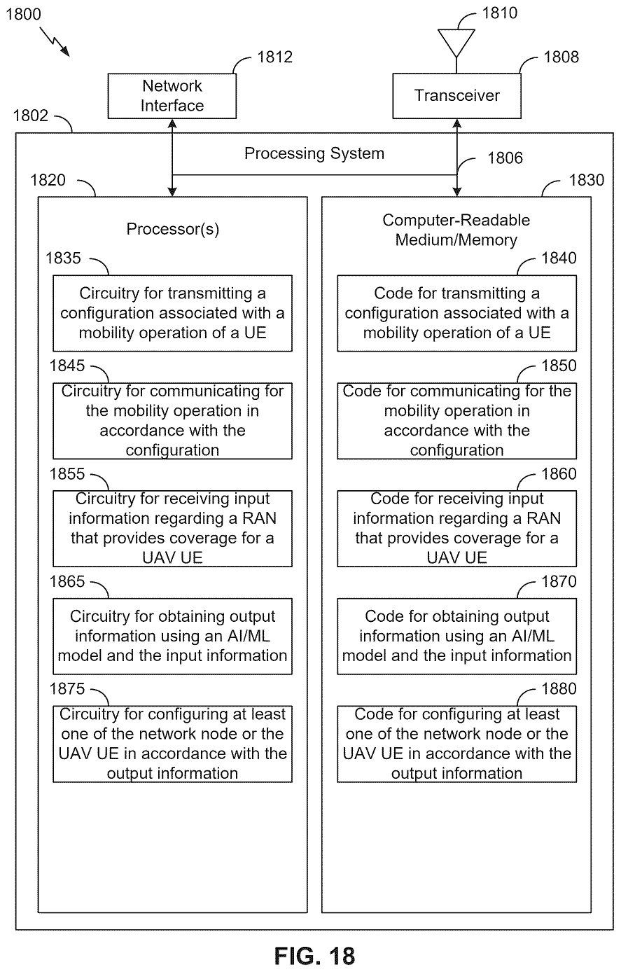

As shown in FIG. 13, in some aspects, process 1300 may include transmitting a configuration associated with a mobility operation of a UE, wherein the UE is associated with an UAV, and wherein the configuration is derived from a target cell type of the mobility operation (block 1310). For example, the network node (e.g., using transceiver 1808 and/or antenna 1810, depicted in FIG. 18) may transmit a configuration associated with a mobility operation of a UE, wherein the UE is associated with an UAV, and wherein the configuration is derived from a target cell type of the mobility operation, as described above.

As further shown in FIG. 13, in some aspects, process 1300 may include communicating for the mobility operation in accordance with the configuration (block 1320). For example, the network node (e.g., using transceiver 1808 and/or antenna 1810, depicted in FIG. 18) may communicate for the mobility operation in accordance with the configuration, as described above.

Process 1300 may include additional aspects, such as any single aspect or any combination of aspects described below and/or in connection with one or more other processes described elsewhere herein.

In a first aspect, the target cell type indicates at least one of a cell size of a target cell of the mobility operation, whether the target cell is associated with a non-terrestrial network or a terrestrial network, or whether the target cell is a high-altitude platform station cell.

In a second aspect, alone or in combination with the first aspect, the configuration configures the UE to switch to a target cell having the target cell type.

In a third aspect, alone or in combination with one or more of the first and second aspects, process 1300 includes generating the configuration based on a threshold number of mobility operations associated with a flight path of the UE.

In a fourth aspect, alone or in combination with one or more of the first through third aspects, generating the configuration comprises generating the configuration based on a zone, associated with a flight path of the UE, having lower than a threshold coverage.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

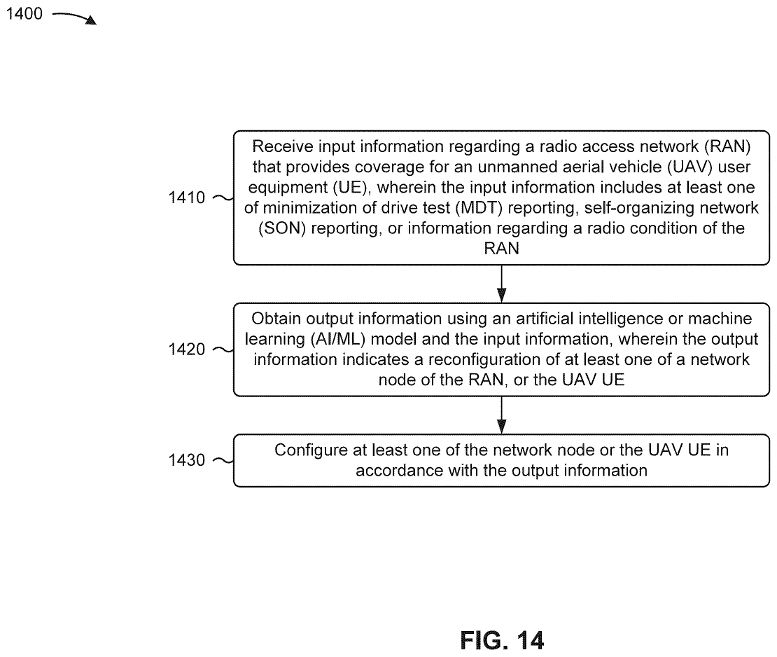

FIG. 14 is a diagram illustrating an example process 1400 performed, for example, at an apparatus or an apparatus of an apparatus, in accordance with the present disclosure. Example process 1400 is an example where an apparatus (e.g., the apparatus of FIGS. 9 and 10, a near-RT RIC, a non-RT RIC, a network node 110, an AI/ML server) performs operations associated with uncrewed aerial vehicle flight path optimization.

As shown in FIG. 14, in some aspects, process 1400 may include receiving input information regarding a RAN that provides coverage for a UAV UE, wherein the input information includes at least one of MDT reporting, SON reporting, or information regarding a radio condition of the RAN (block 1410). For example, the apparatus (e.g., using transceiver 1808 and/or antenna 1810) may receive input information regarding a RAN that provides coverage for an UAV UE, wherein the input information includes at least one of MDT reporting, SON reporting, or information regarding a radio condition of the RAN, as described above.

As further shown in FIG. 14, in some aspects, process 1400 may include obtaining output information using an AI/ML model and the input information, wherein the output information indicates a reconfiguration of at least one of: a network node of the RAN, or the UAV UE (block 1420). For example, the apparatus (e.g., using transceiver 1808 and/or antenna 1810) may obtain output information using an AI/ML model and the input information, wherein the output information indicates a reconfiguration of at least one of: a network node of the RAN, or the UAV UE, as described above.

As further shown in FIG. 14, in some aspects, process 1400 may include configuring at least one of the network node or the UAV UE in accordance with the output information (block 1430). For example, the apparatus (e.g., using transceiver 1808 and/or antenna 1810) may configure at least one of the network node or the UAV UE in accordance with the output information, as described above.

Process 1400 may include additional aspects, such as any single aspect or any combination of aspects described below and/or in connection with one or more other processes described elsewhere herein.

In a first aspect, receiving the input information comprises receiving the input information from the UAV UE.

In a second aspect, alone or in combination with the first aspect, receiving the input information comprises receiving the input information from the network node of the RAN.

In a third aspect, alone or in combination with one or more of the first and second aspects, the reconfiguration includes a modification to a flight path of the UAV UE.

In a fourth aspect, alone or in combination with one or more of the first through third aspects, the reconfiguration includes a change to an altitude of operation of the UAV UE.

In a fifth aspect, alone or in combination with one or more of the first through fourth aspects, the reconfiguration includes a change to one or more cell parameters of the network node.

In a sixth aspect, alone or in combination with one or more of the first through fifth aspects, the one or more cell parameters include at least one of a target cell type, a frequency range, a subcarrier spacing, or a power headroom.

In a seventh aspect, alone or in combination with one or more of the first through sixth aspects, the reconfiguration includes a modification of a parameter for a mobility operation.

In an eighth aspect, alone or in combination with one or more of the first through seventh aspects, the parameter includes at least one of a conditional handover condition, a parameter of a lower-layer triggered mobility operation.

In a ninth aspect, alone or in combination with one or more of the first through eighth aspects, the input information indicates a first number of mobility operations of a flight path of the UAV UE, and wherein the output information is associated with a second number of mobility operations lower than the first number of mobility operations.

In a tenth aspect, alone or in combination with one or more of the first through ninth aspects, the input information indicates a zone, associated with a flight path of the UE, having a first coverage lower than a threshold coverage, and wherein the reconfiguration of the network node or the UAV UE is associated with a second coverage higher than the threshold coverage.

In an eleventh aspect, alone or in combination with one or more of the first through tenth aspects, the apparatus comprises a RAN intelligent controller.

In a twelfth aspect, alone or in combination with one or more of the first through eleventh aspects, the apparatus comprises a SON entity.

In a thirteenth aspect, alone or in combination with one or more of the first through twelfth aspects, the apparatus comprises the network node.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

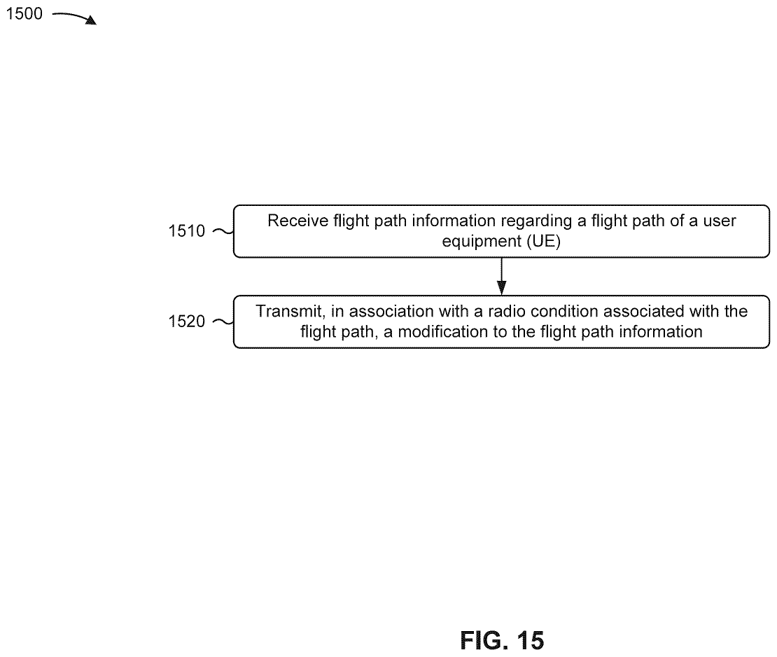

FIG. 15 is a diagram illustrating an example process 1500 performed, for example, at a network node or an apparatus of a network node, in accordance with the present disclosure. Example process 1500 is an example where the apparatus or the network node (e.g., network node 110) performs operations associated with uncrewed aerial vehicle flight path optimization.

As shown in FIG. 15, in some aspects, process 1500 may include receiving flight path information regarding a flight path of a UE (block 1510). For example, the network node (e.g., using transceiver 1808 and/or antenna 1810, depicted in FIG. 18) may receive flight path information regarding a flight path of a UE, as described above.

As further shown in FIG. 15, in some aspects, process 1500 may include transmitting, in association with a radio condition associated with the flight path, a modification to the flight path information (block 1520). For example, the network node (e.g., using transceiver 1808 and/or antenna 1810, depicted in FIG. 18) may transmit, in association with a radio condition associated with the flight path, a modification to the flight path information, as described above.

Process 1500 may include additional aspects, such as any single aspect or any combination of aspects described below and/or in connection with one or more other processes described elsewhere herein.

In a first aspect, the flight path information indicates a first waypoint of the flight path and a second waypoint of the flight path, and wherein the modification to the flight path indicates at least one of a modification to one or more of the first waypoint or the second waypoint, or an additional waypoint for the flight path.

In a second aspect, alone or in combination with the first aspect, the modification to the flight path indicates a change to an altitude of operation of the UE.

In a third aspect, alone or in combination with one or more of the first and second aspects, the radio condition is a cellular coverage level of the flight path.

In a fourth aspect, alone or in combination with one or more of the first through third aspects, the method comprises transmitting a first modification to the flight path, receiving a negotiation message indicating a change associated with the first modification, and transmitting a second modification to the flight path after transmitting the negotiation message, wherein the modification to the flight path is the second modification to the flight path information, and wherein the second modification to the flight path is in accordance with the change associated with the first modification.

In a fifth aspect, alone or in combination with one or more of the first through fourth aspects, the change associated with the first modification is associated with at least one of a battery of the UE or a remaining flight time of the UE.

In a sixth aspect, alone or in combination with one or more of the first through fifth aspects, process 1500 includes receiving information indicating a requested radio condition, wherein the requested radio condition includes at least one of a quality-of-service parameter or a cell parameter, and wherein the modification to the flight path information is in accordance with the requested radio condition.

In a seventh aspect, alone or in combination with one or more of the first through sixth aspects, the quality-of-service parameter indicates at least one of a throughput, a block error rate, or a latency.

In an eighth aspect, alone or in combination with one or more of the first through seventh aspects, the cell parameter indicates at least one of a frequency range, a subcarrier spacing, or a power headroom.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

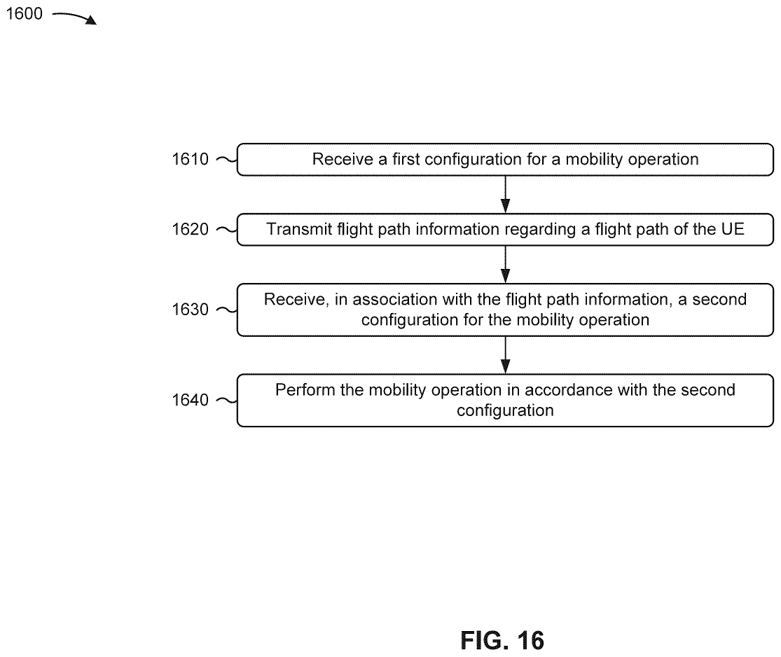

FIG. 16 is a diagram illustrating an example process 1600 performed, for example, at a UE or an apparatus of a UE, in accordance with the present disclosure. Example process 1600 is an example where the apparatus or the UE (e.g., UE 120) performs operations associated with uncrewed aerial vehicle flight path optimization.

As shown in FIG. 16, in some aspects, process 1600 may include receiving a first configuration for a mobility operation (block 1610). For example, the UE (e.g., using transceiver 1708 and/or antenna 1710, depicted in FIG. 17) may receive a first configuration for a mobility operation, as described above.

As further shown in FIG. 16, in some aspects, process 1600 may include transmitting flight path information regarding a flight path of the UE (block 1620). For example, the UE (e.g., using transceiver 1708 and/or antenna 1710, depicted in FIG. 17) may transmit flight path information regarding a flight path of the UE, as described above.

As further shown in FIG. 16, in some aspects, process 1600 may include receiving, in association with the flight path information, a second configuration for the mobility operation (block 1630). For example, the UE (e.g., using transceiver 1708 and/or antenna 1710, depicted in FIG. 17) may receive, in association with the flight path information, a second configuration for the mobility operation, as described above.

As further shown in FIG. 16, in some aspects, process 1600 may include performing the mobility operation in accordance with the second configuration (block 1640). For example, the UE (e.g., using transceiver 1708 or antenna 1710, depicted in FIG. 17) may perform the mobility operation in accordance with the second configuration, as described above.

Process 1600 may include additional aspects, such as any single aspect or any combination of aspects described below and/or in connection with one or more other processes described elsewhere herein.

In a first aspect, the mobility operation is a conditional handover and the second configuration for the mobility operation modifies at least one conditional handover parameter.

In a second aspect, alone or in combination with the first aspect, the at least one conditional handover parameter comprises a condition triggering the conditional handover.

In a third aspect, alone or in combination with one or more of the first and second aspects, the mobility operation is a lower-layer triggered mobility operation and the second configuration for the mobility operation modifies at least one parameter of the lower-layer triggered mobility operation.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram illustrating an example of an implementation of code and circuitry for a communications device 1700, in accordance with the present disclosure. The communications device 1700 may be a UE, or a UE may include the communications device 1700.

The communications device 1700 includes a processing system 1702 coupled to a transceiver 1708 (e.g., a transmitter and/or a receiver, and which may include a single transceivers or multiple transceivers which may perform different operations described as being performed by the transceiver 1708). The transceiver 1708 is configured to transmit and receive signals for the communications device 1700 via an antenna 1710, such as the various signals as described herein. The processing system 1702 may be configured to perform processing functions for the communications device 1700, including processing signals received and/or to be transmitted by the communications device 1700.

The processing system 1702 includes one or more processors 1720. In various aspects, the one or more processors 1720 may include one or more of receive processor 258, transmit processor 264, TX MIMO processor 266, and/or controller/processor 280, as described with respect to FIG. 2. The one or more processors 1720 are coupled to a computer-readable medium/memory 1730 via a bus 1706. In various aspects, the computer-readable medium/memory 1730 may include one or more memories such as memory 282, as described with respect to FIG. 2. In certain aspects, the computer-readable medium/memory 1730 is configured to store instructions (e.g., computer-executable code, processor-executable code) that when executed by the one or more processors 1720, cause the one or more processors 1720 to perform the process 1100, the process 1200, the process 1600, or any aspect related to these. Note that reference to a processor performing a function of communications device 1700 may include one or more processors performing that function of communications device 1700. Note also that reference to one or more processors performing multiple functions may include a first processor performing a first function of the multiple functions and a second processor performing a second function of the multiple functions.

As shown in FIG. 17, the communications device 1700 may include circuitry for transmitting flight path information (circuitry 1735).

As shown in FIG. 17, the communications device 1700 may include, stored in computer-readable medium/memory 1730, code for transmitting flight path information (code 1740).

As shown in FIG. 17, the communications device 1700 may include circuitry for receiving a modification to the flight path information (circuitry 1745).

As shown in FIG. 17, the communications device 1700 may include, stored in computer-readable medium/memory 1730, code for receiving a modification to the flight path information (code 1750).

As shown in FIG. 17, the communications device 1700 may include circuitry for triggering movement of the UE (circuitry 1755).

As shown in FIG. 17, the communications device 1700 may include, stored in computer-readable medium/memory 1730, code for triggering movement of the UE (code 1760).

As shown in FIG. 17, the communications device 1700 may include circuitry for receiving a configuration for a mobility operation (circuitry 1765).

As shown in FIG. 17, the communications device 1700 may include, stored in computer-readable medium/memory 1730, code for receiving a configuration for a mobility operation (code 1770).

As shown in FIG. 17, the communications device 1700 may include circuitry for performing the mobility operation (circuitry 1775).

As shown in FIG. 17, the communications device 1700 may include, stored in computer-readable medium/memory 1730, code for performing the mobility operation in accordance with the second configuration (code 1780).

Various components of the communications device 1700 may provide means for performing the process 1100, the process 1200, the process 1600, or any aspect related to it. For example, means for transmitting, sending, or outputting for transmission may include the modem(s) 254 and/or antenna(s) 252 of the UE 120 and/or transceiver 1708 and antenna 1710 of the communications device 1700 in FIG. 17. Means for receiving or obtaining may include the modem(s) 254 and/or antenna(s) 252 of the UE 120 and/or transceiver 1708 and antenna 1710 of the communications device 1700 in FIG. 17.

FIG. 17 is provided as an example. Other examples may differ from what is described in connection with FIG. 17.

FIG. 18 is a diagram illustrating an example of an implementation of code and circuitry for a communications device 1800, in accordance with the present disclosure. The communications device 1800 may be a network node (such as network node 110 or a disaggregated base station as described with regard to FIG. 3), or a network node may include the communications device 1800.

The communications device 1800 includes a processing system 1802 coupled to a transceiver 1808 (e.g., a transmitter and/or a receiver, and which may include a single transceivers or multiple transceivers which may perform different operations described as being performed by the transceiver 1808). The transceiver 1808 is configured to transmit and receive signals for the communications device 1800 via an antenna 1810 (e.g., one or more antennas), such as the various signals as described herein. The network interface 1812 is configured to obtain and send signals for the communications device 1800 via communications link(s), such as a backhaul link, midhaul link, and/or fronthaul link as described herein, such as with respect to FIG. 3. The processing system 1802 may be configured to perform processing functions for the communications device 1800, including processing signals received and/or to be transmitted by the communications device 1800.

The processing system 1802 includes one or more processors 1820. In various aspects, the one or more processors 1820 may include one or more of receive processor 238, transmit processor 214, TX MIMO processor 216, and/or controller/processor 240, as described with respect to FIG. 2. The one or more processors 1820 are coupled to a computer-readable medium/memory 1830 via a bus 1806. In various aspects, the computer-readable medium/memory 1830 may include one or more memories such as memory 242, as described with respect to FIG. 2. In certain aspects, the computer-readable medium/memory 1830 is configured to store instructions (e.g., computer-executable code, processor-executable code) that when executed by the one or more processors 1820, cause the one or more processors 1820 to perform the process 1300, the process 1400, or the process 1500, or any aspect related to these processes. Note that reference to a processor performing a function of communications device 1800 may include one or more processors performing that function of communications device 1800. Note also that reference to one or more processors performing multiple functions may include a first processor performing a first function of the multiple functions and a second processor performing a second function of the multiple functions.

As shown in FIG. 18, the communications device 1800 may include circuitry for transmitting a configuration associated with a mobility operation of a UE (circuitry 1835).

As shown in FIG. 18, the communications device 1800 may include, stored in computer-readable medium/memory 1830, code for transmitting a configuration associated with a mobility operation of a UE (code 1840).

As shown in FIG. 18, the communications device 1800 may include circuitry for communicating for the mobility operation in accordance with the configuration (circuitry 1845).

As shown in FIG. 18, the communications device 1800 may include, stored in computer-readable medium/memory 1830, code for communicating for the mobility operation in accordance with the configuration (code 1850).

As shown in FIG. 18, the communications device 1800 may include circuitry for receiving input information regarding a RAN that provides coverage for a UAV UE (circuitry 1855).

As shown in FIG. 18, the communications device 1800 may include, stored in computer-readable medium/memory 1830, code for receiving input information regarding a RAN that provides coverage for a UAV UE (code 1860).

As shown in FIG. 18, the communications device 1800 may include circuitry for obtaining output information using an AI/ML model and the input information (circuitry 1865).

As shown in FIG. 18, the communications device 1800 may include, stored in computer-readable medium/memory 1830, code for obtaining output information using an AI/ML model and the input information (code 1870).

As shown in FIG. 18, the communications device 1800 may include circuitry for configuring at least one of the network node or the UAV UE in accordance with the output information (circuitry 1875).

As shown in FIG. 18, the communications device 1800 may include, stored in computer-readable medium/memory 1830, code for configuring at least one of the network node or the UAV UE in accordance with the output information (code 1880).

Various components of the communications device 1800 may provide means for performing the process 1300, the process 1400, or the process 1500, or any aspect related to these processes. For example, means for transmitting, sending, or outputting for transmission may include the modem(s) 232 and/or antenna(s) 234 of the network node 110 and/or the transceiver 1808 and/or antenna 1810 of the communications device 1800 in FIG. 18. Means for receiving or obtaining may include the modem(s) 232 and/or antenna(s) 234 of the network node 110 and/or the transceiver 1808 and/or antenna 1810 of the communications device 1800 in FIG. 18.

FIG. 18 is provided as an example. Other examples may differ from what is described in connection with FIG. 18.

The following provides an overview of some Aspects of the present disclosure:

Aspect 1: A method of wireless communication performed by a user equipment (UE), comprising: transmitting flight path information regarding a flight path of the UE; receiving a modification to the flight path information, wherein the modification is associated with a radio condition, wherein the radio condition is associated with the flight path; and triggering movement of the UE in association with the modification to the flight path information.

Aspect 2: The method of Aspect 1, wherein the flight path information indicates a first waypoint of the flight path and a second waypoint of the flight path, and wherein the modification to the flight path information indicates at least one of: a modification to one or more of the first waypoint or the second waypoint, or an additional waypoint for the flight path.

Aspect 3: The method of any of Aspects 1-2, wherein the modification to the flight path information indicates a change to an altitude of operation of the UE.

Aspect 4: The method of any of Aspects 1-3, wherein triggering movement in association with the modification to the flight path information comprises providing the modification to the flight path information to an uncrewed aerial vehicle (UAV) motion tracker.

Aspect 5: The method of any of Aspects 1-4, wherein the radio condition is a cellular coverage level of the flight path.

Aspect 6: The method of any of Aspects 1-5, wherein the method comprises: receiving a first modification to the flight path; transmitting a negotiation message indicating a change associated with the first modification; and receiving a second modification to the flight path after transmitting the negotiation message, wherein the modification to the flight path is the second modification to the flight path information.

Aspect 7: The method of Aspect 6, wherein the change associated with the first modification is associated with at least one of a battery of the UE or a remaining flight time of the UE.

Aspect 8: The method of any of Aspects 1-7, comprising: transmitting information indicating a requested radio condition, wherein the requested radio condition includes at least one of a quality-of-service parameter or a cell parameter, and wherein receiving the modification to the flight path information comprises receiving the modification in accordance with the requested radio condition.

Aspect 9: The method of Aspect 8, wherein the quality-of-service parameter indicates at least one of a throughput, a block error rate, or a latency.

Aspect 10: The method of Aspect 8, wherein the cell parameter indicates at least one of a frequency range, a subcarrier spacing, or a power headroom.

Aspect 11: A method of wireless communication performed by a user equipment (UE), comprising: receiving a first configuration for a mobility operation; transmitting flight path information regarding a flight path of the UE; receiving, in association with the flight path information, a second configuration for the mobility operation; and performing the mobility operation in accordance with the second configuration.

Aspect 12: The method of Aspect 11, wherein the mobility operation is a conditional handover and the second configuration for the mobility operation modifies at least one conditional handover parameter.

Aspect 13: The method of Aspect 12, wherein the at least one conditional handover parameter comprises a condition triggering the conditional handover.

Aspect 14: The method of any of Aspects 11-13, wherein the mobility operation is a lower-layer triggered mobility operation and the second configuration for the mobility operation modifies at least one parameter of the lower-layer triggered mobility operation.

Aspect 15: A method of wireless communication performed by a network node, comprising: transmitting a configuration associated with a mobility operation of a user equipment (UE), wherein the UE is associated with an uncrewed aerial vehicle (UAV), and wherein the configuration is derived from a target cell type of the mobility operation; and communicating for the mobility operation in accordance with the configuration.

Aspect 16: The method of Aspect 15, wherein the target cell type indicates at least one of: a cell size of a target cell of the mobility operation, whether the target cell is associated with a non-terrestrial network or a terrestrial network, or whether the target cell is a high-altitude platform station cell.

Aspect 17: The method of any of Aspects 15-16, wherein the configuration configures the UE to switch to a target cell having the target cell type.

Aspect 18: The method of any of Aspects 15-17, comprising generating the configuration.

Aspect 19: The method of Aspect 18, wherein generating the configuration comprises generating the configuration based on a threshold number of mobility operations associated with a flight path of the UE.

Aspect 20: The method of Aspect 18, wherein generating the configuration comprises generating the configuration based on a zone, associated with a flight path of the UE, having lower than a threshold coverage.

Aspect 21: A method performed by an apparatus, comprising: receiving input information regarding a radio access network (RAN) that provides coverage for an unmanned aerial vehicle (UAV) user equipment (UE), wherein the input information includes at least one of minimization of drive test (MDT) reporting, self-organizing network (SON) reporting, or information regarding a radio condition of the RAN; obtaining output information using an artificial intelligence or machine learning (AI/ML) model and the input information, wherein the output information indicates a reconfiguration of at least one of: a network node of the RAN, or the UAV UE; and configuring at least one of the network node or the UAV UE in accordance with the output information.

Aspect 22: The method of Aspect 21, wherein receiving the input information comprises receiving the input information from the UAV UE.

Aspect 23: The method of any of Aspects 21-22, wherein receiving the input information comprises receiving the input information from the network node of the RAN.

Aspect 24: The method of any of Aspects 21-23, wherein the reconfiguration includes a modification to a flight path of the UAV UE.

Aspect 25: The method of any of Aspects 21-24, wherein the reconfiguration includes a change to an altitude of operation of the UAV UE.

Aspect 26: The method of any of Aspects 21-25, wherein the reconfiguration includes a change to one or more cell parameters of the network node.

Aspect 27: The method of Aspect 26, wherein the one or more cell parameters include at least one of: a target cell type, a frequency range, a subcarrier spacing, or a power headroom.

Aspect 28: The method of any of Aspects 21-27, wherein the reconfiguration includes a modification of a parameter for a mobility operation.

Aspect 29: The method of Aspect 28, wherein the parameter includes at least one of: a conditional handover condition, a parameter of a lower-layer triggered mobility operation.

Aspect 30: The method of any of Aspects 21-29, wherein the input information indicates a first number of mobility operations of a flight path of the UAV UE, and wherein the output information is associated with a second number of mobility operations lower than the first number of mobility operations.

Aspect 31: The method of any of Aspects 21-30, wherein the input information indicates a zone, associated with a flight path of the UE, having a first coverage lower than a threshold coverage, and wherein the reconfiguration of the network node or the UAV UE is associated with a second coverage higher than the threshold coverage.

Aspect 32: The method of any of Aspects 21-31, wherein the apparatus comprises a RAN intelligent controller.

Aspect 33: The method of any of Aspects 21-32, wherein the apparatus comprises a SON entity.

Aspect 34: The method of any of Aspects 21-33, wherein the apparatus comprises the network node.

Aspect 35: A method of wireless communication performed by a network node, comprising: receiving flight path information regarding a flight path of a user equipment (UE); and transmitting, in association with a radio condition associated with the flight path, a modification to the flight path information.

Aspect 36: The method of Aspect 35, wherein the flight path information indicates a first waypoint of the flight path and a second waypoint of the flight path, and wherein the modification to the flight path indicates at least one of: a modification to one or more of the first waypoint or the second waypoint, or an additional waypoint for the flight path.

Aspect 37: The method of any of Aspects 35-36, wherein the modification to the flight path indicates a change to an altitude of operation of the UE.

Aspect 38: The method of any of Aspects 35-37, wherein the radio condition is a cellular coverage level of the flight path.

Aspect 39: The method of any of Aspects 35-38, wherein the method comprises: transmitting a first modification to the flight path; receiving a negotiation message indicating a change associated with the first modification; and transmitting a second modification to the flight path after transmitting the negotiation message, wherein the modification to the flight path is the second modification to the flight path information, and wherein the second modification to the flight path is in accordance with the change associated with the first modification.

Aspect 40: The method of Aspect 39, wherein the change associated with the first modification is associated with at least one of a battery of the UE or a remaining flight time of the UE.

Aspect 41: The method of any of Aspects 35-40, comprising: receiving information indicating a requested radio condition, wherein the requested radio condition includes at least one of a quality-of-service parameter or a cell parameter, and wherein the modification to the flight path information is in accordance with the requested radio condition.

Aspect 42: The method of Aspect 41, wherein the quality-of-service parameter indicates at least one of a throughput, a block error rate, or a latency.

Aspect 43: The method of Aspect 41, wherein the cell parameter indicates at least one of a frequency range, a subcarrier spacing, or a power headroom.

Aspect 44: A method of wireless communication performed by a user equipment (UE), comprising: receiving a first configuration for a mobility operation; transmitting flight path information regarding a flight path of the UE; receiving, in association with the flight path information, a second configuration for the mobility operation; and performing the mobility operation in accordance with the second configuration.

Aspect 45: The method of Aspect 44, wherein the mobility operation is a conditional handover and the second configuration for the mobility operation modifies at least one conditional handover parameter.

Aspect 46: The method of Aspect 45, wherein the at least one conditional handover parameter comprises a condition triggering the conditional handover.

Aspect 47: The method of any of Aspects 44-46, wherein the mobility operation is a lower-layer triggered mobility operation and the second configuration for the mobility operation modifies at least one parameter of the lower-layer triggered mobility operation.

Aspect 48: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-47.

Aspect 49: An apparatus for wireless communication at a device, the apparatus comprising one or more memories and one or more processors coupled to the one or more memories, the one or more processors configured to cause the device to perform the method of one or more of Aspects 1-47.

Aspect 50: An apparatus for wireless communication, the apparatus comprising at least one means for performing the method of one or more of Aspects 1-47.

Aspect 51: A non-transitory computer-readable medium storing code for wireless communication, the code comprising instructions executable by one or more processors to perform the method of one or more of Aspects 1-47.

Aspect 52: A non-transitory computer-readable medium storing a set of instructions for wireless communication, the set of instructions comprising one or more instructions that, when executed by one or more processors of a device, cause the device to perform the method of one or more of Aspects 1-47.

Aspect 53: A device for wireless communication, the device comprising a processing system that includes one or more processors and one or more memories coupled with the one or more processors, the processing system configured to cause the device to perform the method of one or more of Aspects 1-47.

Aspect 54: An apparatus for wireless communication at a device, the apparatus comprising one or more memories and one or more processors coupled to the one or more memories, the one or more processors individually or collectively configured to cause the device to perform the method of one or more of Aspects 1-47.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus configured for wireless communication, comprising:
one or more antennas; and
a processing system that includes processor circuitry and memory circuitry that stores code for the processor circuitry, the processing system configured to cause the apparatus to:
receive input information regarding a radio access network (RAN) that provides coverage for an unmanned aerial vehicle (UAV) user equipment (UE), wherein the input information includes at least one of minimization of drive test (MDT) reporting, self-organizing network (SON) reporting, or information regarding a radio condition of the RAN;
obtain output information using an artificial intelligence or machine learning (AI/ML) model and the input information, wherein the output information indicates a reconfiguration of at least one of:
a network node of the RAN, or
the UAV UE; and
configure at least one of the network node or the UAV UE in accordance with the output information.

2. The apparatus of claim 1, wherein the processing system, to cause the apparatus to receive the input information, is configured to cause the apparatus to receive the input information from the UAV UE.

3. The apparatus of claim 1, wherein the processing system, to cause the apparatus to receive the input information, is configured to cause the apparatus to receive the input information from the network node of the RAN.

4. The apparatus of claim 1, wherein the reconfiguration includes a modification to a flight path of the UAV UE.

5. The apparatus of claim 1, wherein the reconfiguration includes a change to an altitude of operation of the UAV UE.

6. The apparatus of claim 1, wherein the reconfiguration includes a change to one or more cell parameters of the network node.

7. The apparatus of claim 6, wherein the one or more cell parameters include at least one of:
a target cell type,
a frequency range,
a subcarrier spacing, or
a power headroom.

8. The apparatus of claim 1, wherein the reconfiguration includes a modification of a parameter for a mobility operation.

9. The apparatus of claim 8, wherein the parameter includes at least one of:
a conditional handover condition,
a parameter of a lower-layer triggered mobility operation.

10. The apparatus of claim 1, wherein the input information indicates a first number of mobility operations of a flight path of the UAV UE, and wherein the output information is associated with a second number of mobility operations lower than the first number of mobility operations.

11. A method performed by an apparatus configured for wireless communication, comprising:
receiving input information regarding a radio access network (RAN) that provides coverage for an unmanned aerial vehicle (UAV) user equipment (UE), wherein the input information includes at least one of minimization of drive test (MDT) reporting, self-organizing network (SON) reporting, or information regarding a radio condition of the RAN;
obtaining output information using an artificial intelligence or machine learning (AI/ML) model and the input information, wherein the output information indicates a reconfiguration of at least one of:
a network node of the RAN, or
the UAV UE; and
configuring at least one of the network node or the UAV UE in accordance with the output information.

12. The method of claim 11, wherein receiving the input information includes receiving the input information from the UAV UE.

13. The method of claim 11, wherein receiving the input information includes receiving the input information from the network node of the RAN.

14. The method of claim 11, wherein the reconfiguration includes a modification to a flight path of the UAV UE.

15. The method of claim 11, wherein the reconfiguration includes a change to an altitude of operation of the UAV UE.

16. The method of claim 11, wherein the reconfiguration includes a change to one or more cell parameters of the network node.

17. The method of claim 16, wherein the one or more cell parameters include at least one of:
a target cell type,
a frequency range,
a subcarrier spacing, or
a power headroom.

18. A non-transitory processor-readable storage medium having processor-executable instructions stored thereon configured to cause one or more processors of an apparatus to:
receive input information regarding a radio access network (RAN) that provides coverage for an unmanned aerial vehicle (UAV) user equipment (UE), wherein the input information includes at least one of minimization of drive test (MDT) reporting, self-organizing network (SON) reporting, or information regarding a radio condition of the RAN;
obtain output information using an artificial intelligence or machine learning (AI/ML) model and the input information, wherein the output information indicates a reconfiguration of at least one of:
a network node of the RAN, or
the UAV UE; and
configure at least one of the network node or the UAV UE in accordance with the output information.

19. The non-transitory processor-readable storage medium of claim 18, wherein the processor-executable instructions stored thereon are further configured to cause the one or more processors, to cause the apparatus to receive the input information, are configured to cause the apparatus to receive the input information from the UAV UE.

20. The non-transitory processor-readable storage medium of claim 18, wherein the processor-executable instructions stored thereon are further configured to cause the one or more processors, to cause the apparatus to receive the input information, are configured to cause the apparatus to receive the input information from the network node of the RAN.
